(19) United States
(12) Patent Application Publication
(10) Pub. No.: US 2011/0013202 A1
(43) Pub. Date: Jan. 20, 2011

(54) IMAGE PROCESSING APPARATUS, IMAGE PROCESSING METHOD, AND PROGRAM FOR EXECUTING THE IMAGE PROCESSING METHOD

(75) Inventor: Mizuki Muramatsu, Machida-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/835,550

(22) Filed: Jul. 13, 2010

(30) Foreign Application Priority Data
Jul. 16, 2009 (JP) 2009-167905

(51) Int. Cl. G06K 15/02

(52) U.S. Cl. 358/1.2

(57) ABSTRACT

An apparatus includes a sensor unit including a plurality of sensors, a determination unit configured to acquire attribute information of a document image and to determine a plurality of resolutions according to the acquired attribute information, a frame number determination unit configured to determine a number of frames of frame image data, a first conversion unit configured to generate the plurality of pieces by performing interpolation processing on a partial area of the document image using frame image data that corresponds to the number of frames, an output unit configured to display on a preview screen the plurality of pieces of image data, and a second conversion unit configured to generate image data having a resolution higher than a reading resolution by performing interpolation processing using frame image data.

### BACKGROUND OF THE INVENTION

1. Field of the Invention

The present invention relates to an image processing apparatus, a method for controlling the image processing apparatus, and a program for executing the control method.

2. Description of the Related Art

There is a conventional technique generally referred to as “super-resolution”, which is usable to generate an image having an improved resolution based on a plurality of frames of predetermined resolution image data. According to the “super-resolution” technique, a high-resolution image converted from low-resolution images can be obtained.

Therefore, a high-resolution image can be obtained by an ordinary device having a relatively lower resolution as discussed in “Super-resolution Processing Based on a Plurality of Pieces of Digital Image Data” (Ricoh Technical Report No. 24, Nov., 1998).

The execution of the super-resolution technique requires image data corresponding to a plurality of frames that are different in reading position (hereinafter, referred to as “phase”) of a document to be read by an amount comparable to a sub pixel (i.e., a size smaller than one pixel).

The above-described technique is applicable to a wide variety of fields including moving image processing. When the super-resolution processing is performed, image data corresponding to a plurality of frames is required to generate an image of one pixel. Therefore, a large amount of data is required for the super-resolution processing and a controller is required to perform a large amount of calculations.

However, it may be unnecessary to always use image data corresponding to a large amount of frames when the super-resolution processing is performed. For example, image data of all frames read in a reading operation may not be used to realize an output image quality (resolution) required by a user.

As discussed in Japanese Patent Application Laid-Open No. 2006-092450, only a part of images continuously sent from a camera can be selected as a target image portion to be subjected to the super-resolution processing, according to which a high-definition image can be generated and displayed in an enlarged size.

In this case, the data amount to be used in the super-resolution processing and the calculation amount can be reduced by determining the number of frames that can be processed for the super-resolution processing according to an image size of the target image portion selected by a user before starting the super-resolution processing.

However, according to the technique discussed in Japanese Patent Application Laid-Open No. 2006-092450, a significant size of resource is required to perform a real-time display of super-resolution processed images generated using a plurality of pieces of frame image data.

Accordingly, if the designated size of the image data becomes larger, the processing amount for each pixel increases. Therefore, the number of pieces of usable frame image data decreases. In this manner, according to the technique discussed in Japanese Patent Application Laid-Open No. 2006-092450, the number of frames to be used in the super-resolution processing is determined according to the size of an image. However, in this case, information taken into consideration in determining the number of frames is limited to the image size.

On the other hand, a multifunction peripheral (MFP) or a scanner, which is operable as an image processing apparatus, can be used to read a document and acquire a plurality of pieces of image data from the read document, and then perform super-resolution processing based on the acquired image data, and finally output a super-resolution processed image.

In this case, the image data of all frames read in the reading operation may not be used to realize an output image quality (resolution) required by a user.

However, even if the multifunction peripheral automatically detects a desired resolution based on an analysis on an image to be read and setting of the super-resolution processing is performed considering the detection result, the resolution of an output image may not be satisfactory for the user.

Further, in a case where image data of all frames having been read is always used in super-resolution processing, it is necessary to store the entire read data. As a result, a memory is required to store an excessive amount of data that exceeds the amount of data to be output.

### SUMMARY OF THE INVENTION

According to an aspect of the present invention, an image processing apparatus includes a sensor unit including a plurality of sensors, of which a first sensor and a second sensor are disposed adjacent to each other such that a shift between the first sensor and the second sensor in a reading position of a document image is less than one pixel. The image processing apparatus further includes a determination unit configured to acquire attribute information of the image and determine a plurality of resolutions according to the acquired attribute information, a frame number determination unit configured to determine a number of frames of frame image data, from a plurality of pieces of frame image data, which are used to convert the image into each of a plurality of pieces of image data having the respective plurality of resolutions, a first high resolution conversion unit configured to generate the plurality of pieces of image data having the respective plurality of resolutions by performing interpolation processing on a partial area of the image using frame image data that corresponds to the determined number of frames, an output unit configured to display on a preview screen the plurality of pieces of image data, and a second high resolution conversion unit configured to generate image data having a resolution higher than a reading resolution by performing interpolation processing using frame image data corresponding to the number of frames used to generate image data selected among the plurality of pieces of image data displayed by the output unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic view illustrating an image processing apparatus according to a first exemplary embodiment of the present invention.

FIG. 2 is a block diagram illustrating a detailed configuration of a controller of the image processing apparatus according to an exemplary embodiment of the present invention.

FIG. 3 is a block diagram illustrating an internal configuration of a scanner image processing unit according to an exemplary embodiment of the present invention.

FIG. 4 illustrates examples of images that can be acquired by a scanner device.

FIG. 5 is a block diagram illustrating an internal configuration of a printer image processing unit according to an exemplary embodiment of the present invention.

FIG. 6 is a flowchart illustrating an example procedure of super-resolution processing mode setting processing that can be performed by the controller of the image processing apparatus according to the first exemplary embodiment of the present invention.

FIG. 7 illustrates an example of a correspondence table stored in a ROM.

FIG. 8A illustrates an input document.

FIG. 8B illustrates an example screen displayed on an operation unit that includes super-resolution processed images.

FIG. 9 illustrates an example of super-resolution processing according to an exemplary embodiment of the present invention.

FIG. 10 illustrates an example of mixing processing of the super-resolution processing according to an exemplary embodiment of the present invention.

FIG. 11 is a flowchart illustrating an example procedure of partial area extraction processing that can be performed by the controller of the image processing apparatus according to the first exemplary embodiment of the present invention.

FIGS. 12A and 12B illustrate an example of the partial area extraction processing according to the first exemplary embodiment of the present invention.

FIG. 13 is a flowchart illustrating another example of the super-resolution processing mode setting processing that can be performed by the controller of the image processing apparatus according to a second exemplary embodiment of the present invention.

FIG. 14 is a flowchart illustrating an example procedure of spatial frequency calculation processing that can be performed by the controller of the image processing apparatus according to the second exemplary embodiment of the present invention.

FIG. 15 is a flowchart illustrating an example procedure of image data feature attribute extraction processing that can be performed by the controller of the image processing apparatus according to the second exemplary embodiment of the present invention.

FIGS. 16A to 16C illustrate examples of a relationship between an effective space power spectrum and the spatial frequency obtained though the partial area extraction processing.

FIG. 17 is a flowchart illustrating another example of the partial area extraction processing that can be performed by the controller of the image processing apparatus according to the second exemplary embodiment of the present invention.

FIG. 18 is a flowchart illustrating another example of the super-resolution processing mode setting processing that can be performed by the controller of the image processing apparatus according to a third exemplary embodiment of the present invention.

FIGS. 19A and 19B illustrate examples of super-resolution processed preview screens displayed on the operation unit according to the third exemplary embodiment of the present invention.

FIG. 20A illustrates an inclined area sensor, and FIGS. 20B and 20C illustrate examples of image data that can be obtained by the area sensor illustrated in FIG. 20A.

FIG. 21 is a flowchart illustrating another example of the super-resolution processing mode setting processing that can be performed by the controller of the image processing apparatus according to a fifth exemplary embodiment of the present invention.

FIG. 22 illustrates an example of a correspondence table stored in a ROM according to the fifth exemplary embodiment of the present invention.

FIGS. 23A to 23C illustrate examples of super-resolution processed preview screens displayed on the operation unit according to the fifth exemplary embodiment of the present invention.

FIG. 24A illustrates an area sensor, and FIGS. 24B to 24D illustrate examples of image data that can be obtained by the area sensor illustrated in FIG. 24A.

### DESCRIPTION OF THE EMBODIMENTS

Various exemplary embodiments, features, and aspects of the invention will be described in detail below with reference to the drawings.

An image processing apparatus according to an exemplary embodiment of the present invention is equipped with a color scanner. An example method according to an exemplary embodiment of the present invention enables the image processing apparatus to generate high resolution images by using an area sensor that can acquire a plurality of images that mutually shift in phase.

The scanner is not limited to a color type and can be a monochrome type. Further, the sensor is not limited to the area sensor and can be replaced with a line sensor if the line sensor can acquire image data corresponding to a plurality of frames that mutually shift in phase by an amount less than one pixel.

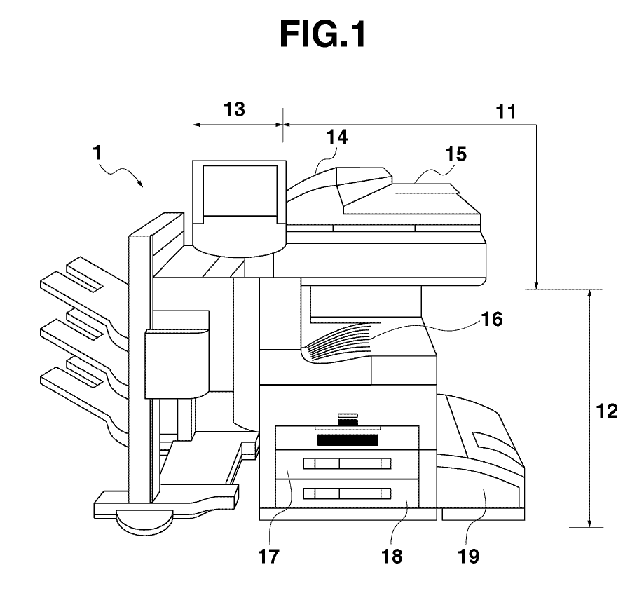

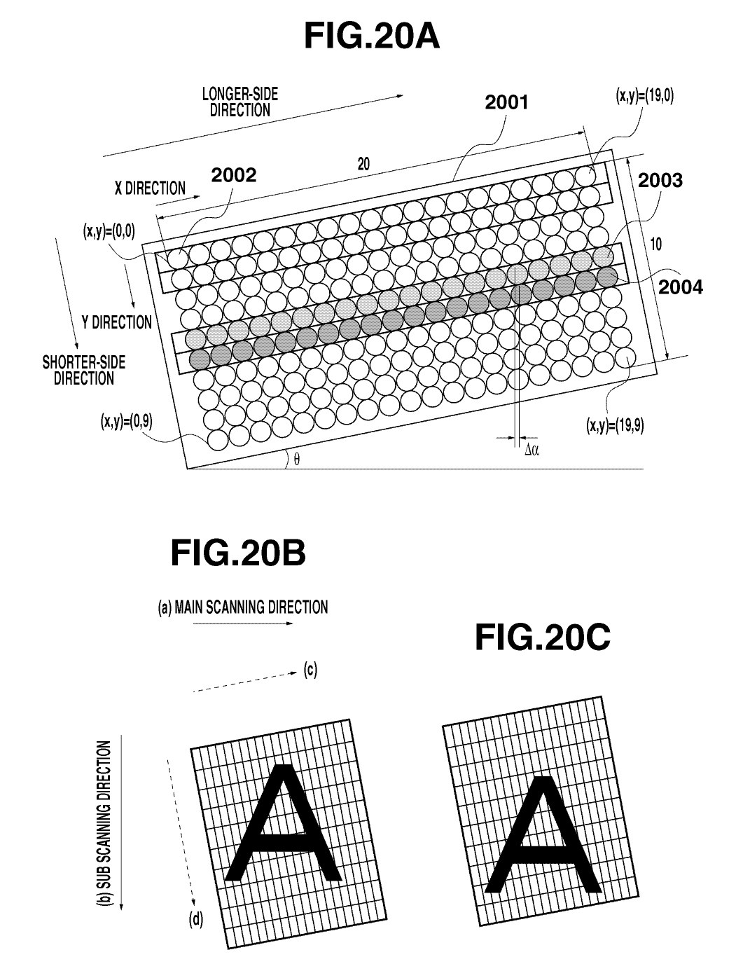

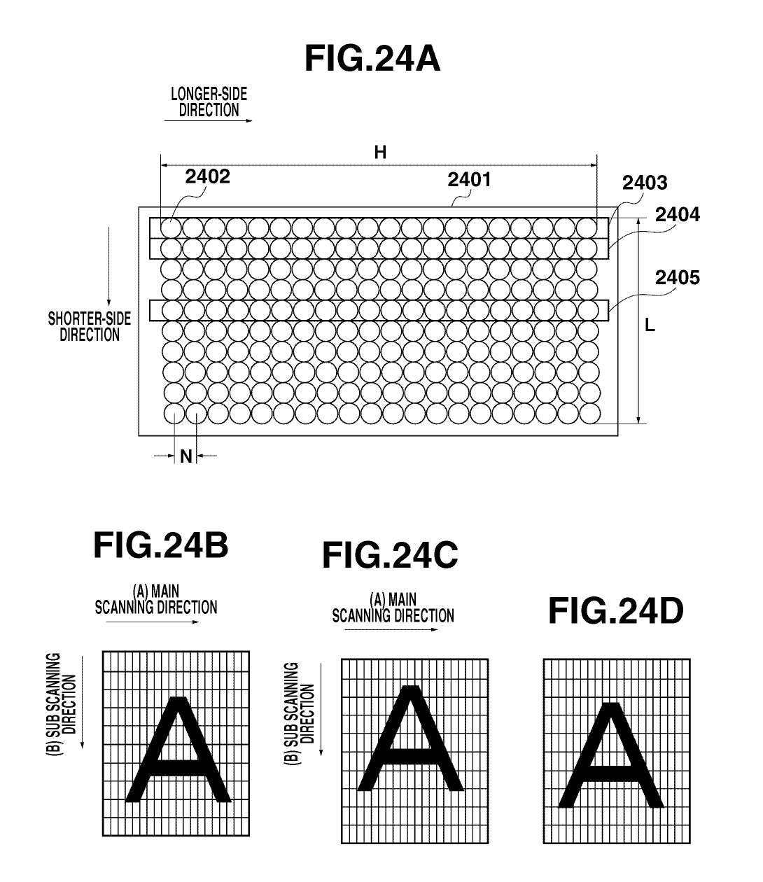

Examples of the area sensor are described below in more detail with reference to FIGS. 20A to 20C and FIGS. 24A to 24D. FIG. 1 illustrates an external appearance of an image processing apparatus 1. The image processing apparatus 1 includes a scanner unit 11 that reads a document image, a printer unit 12 that reproduces an image based on read image data, and an operation unit 13 that enables users to designate various operation settings for the image processing apparatus 1.

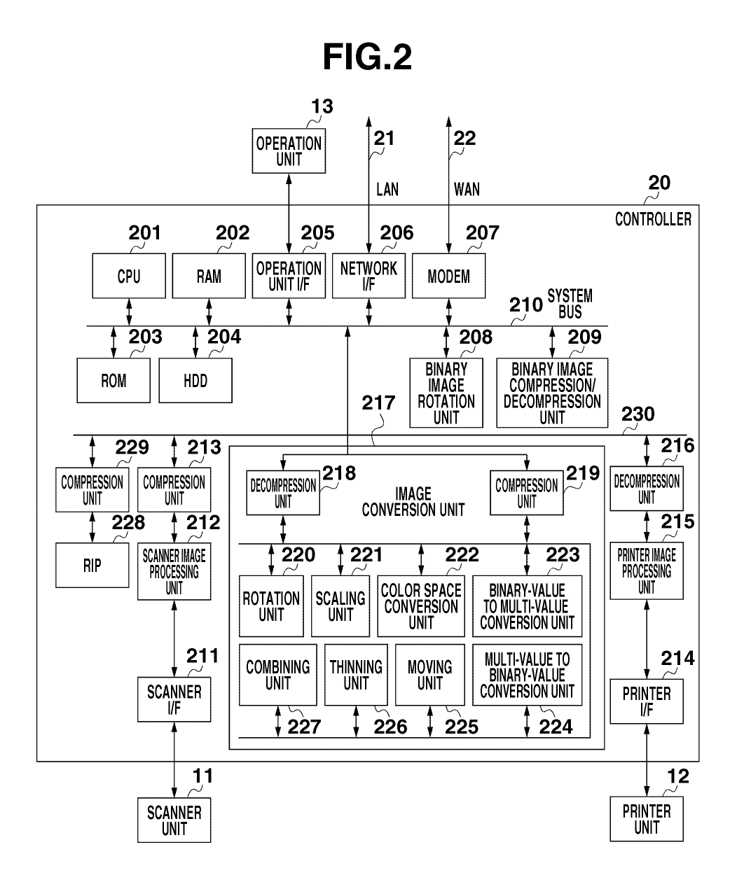

The scanner unit 11 includes a light source that irradiates a document with exposure and scanning light and a charge coupled device (CCD) that receives reflection light from the document. The scanner unit 11 converts information representing an image of the scanned document into an electric signal. The scanner unit 11 further converts the electric signal into luminance signals of R, G, and B colors. The scanner unit 11 outputs the luminance signals, as image data, to a controller 20 that is described below in more detail with reference to FIG. 2.

The scanner unit 11 includes a document feeder 15 equipped with a tray 14 on which a document to be scanned can be set. If a user operates the operation unit 13 to instruct starting a document reading operation, the controller 20 sends a document reading instruction to the scanner unit 11.

When the scanner unit 11 receives this instruction, the scanner unit 11 successively feeds documents one by one from the tray 14 of the document feeder 15 to cause a reading unit (not illustrated) to perform a document reading operation.

A document reading method according to the present exemplary embodiment is not limited to an automatic feeding operation performed by the document feeder 15. Another document reading method may include placing a document on a document positioning glass plate (not illustrated) and moving an exposure unit to perform a document scanning operation.

The printer unit 12 is an image processing device that can form an image on a sheet based on image data received from the controller 20. An image processing method according to the present exemplary embodiment is an electro-photographic method using a photosensitive drum or a photosensitive belt. The present invention is not limited to the above-described method.

For example, an inkjet method for discharging ink droplets from micro nozzles of an array is employable to perform printing on a sheet. The printer unit 12 includes a plurality of sheet cassettes 17, 18, and 19, in which various types of sheets (that are different in sheet size or in sheet orientation) can be stored. The printer unit 12 further includes a discharge tray 16 to which printed sheets are discharged.

FIG. 2 is a block diagram illustrating a detailed configuration of the controller 20 of the image processing apparatus 1.

The controller 20 is electrically connected to the scanner unit 11 and the printer unit 12. The controller 20 is also connected to external apparatuses via a local area network (LAN) 21 and a wide area network (WAN) 22. Therefore, the controller 20 can input and output image data and device information.

The CPU 201 can integrally control accesses to various devices that are currently connected based on a control program stored in the ROM 203 and can further integrally control various processing to be performed in the controller 20.

A random access memory (RAM) 202 can serve as a system work memory when the CPU 201 operates and also can serve as a memory capable of temporarily storing image data. The RAM 202 is constituted by a static random access memory (SRAM) that can hold stored contents even after the power source is turned off and a dynamic random access memory (DRAM) that cannot retain stored contents if the power source is turned off. The ROM 203 stores a program for booting the apparatus. A hard disk drive (HDD) 204 can store system software and image data.

An operation unit interface (I/F) 205 is an interface unit that connects the system bus 210 to the operation unit 13. The operation unit I/F 205 can receive image data to be displayed on the operation unit 13 via the system bus 210 and output the received image data to the operation unit 13. Further, the operation unit I/F 205 can receive information input via the operation unit 13 and output the received information to the system bus 210.

A network interface (I/F) 206, connected between the LAN 21 and the system bus 210, performs processing for inputting and outputting information. A modem 207, connected between the WAN 22 and the system bus 210, can perform processing for inputting and outputting information.

A binary image rotation unit 208 can convert the orientation of image data to be transmitted. A binary image compression/decompression unit 209 can convert image data to be transmitted into image data having a predetermined resolution or an appropriate resolution suitable for an output destination device. The binary image compression/decompression unit 209 can perform compression and decompression processing on the image data using an appropriate method (e.g., JBIG, MMR, MR, or MH). An image bus 230 is a transmission line usable for transmitting and receiving image data and can be constituted by PCI bus or IEEE 1394.

A scanner image processing unit 212 can perform various (correction, modification, and editing) processing on image data received from the scanner unit 11 via a scanner I/F 211. The scanner image processing unit 212 can determine whether the received image data is for a color document or a monochrome document. The scanner image processing unit 212 can further determine whether the received image data is for a text document or a photo document.

The scanner image processing unit 212 associates a determination result with the image data. The information associated with the image data is referred to as attribute data. An example of the processing that can be performed by the scanner image processing unit 212 is described below in more detail.

A compression unit 213 can receive image data and divide the received image data into a plurality of blocks each having a size of 32 pixels×32 pixels. Each block of image data composed of 32 pixels×32 pixels is referred to as “tile data.”

In a document (a paper medium to be read), an area corresponding to the tile data is referred to as a tile image. Header information added to each tile data includes an average luminance value in the 32 pixels×32 pixels block and coordinate values indicating the portion of the tile image on the document. Further, the compression unit 213 can compress image data composed of a plurality of tile data.

A decompression unit 216 can decompress image data composed of a plurality of tile data, and can send rasterized image data to a printer image processing unit 215.

The printer image processing unit 215 can receive image data from the decompression unit 216, and can perform image processing on the received image data referring to attribute data associated with the image data. The image data having been subjected to the image processing is output to the printer unit 12 via a printer I/F 214. An example of the processing that can be performed by the printer image processing unit 215 is described below in more detail.

An image conversion unit 217 can perform predetermined conversion processing on image data. The image conversion unit 217 includes the following processing units.

A decompression unit 218 can decompress received image data. A compression unit 219 can compress received image data. A rotation unit 220 can rotate received image data. A scaling unit 221 can perform resolution conversion processing (e.g., conversion from 600 dpi to 200 dpi) on received image data.

A color space conversion unit 222 can convert a color space of received image data. For example, the color space conversion unit 222 performs background color removal processing using a matrix or a table, which is conventionally known. Further, the color space conversion unit 222 can perform LOG conversion processing (e.g., RGB→CMY) and can output color correction processing (e.g., CMY→CMYK), which are conventionally known.

A binary-value to multi-value conversion unit 223 can convert received image data having two gradation levels into image data having 256 gradation levels. On the other hand, a multi-value to binary-value conversion unit 224 can convert received image data having 256 gradation levels into image data having two gradation levels. To this end, for example, the multi-value to binary-value conversion unit 224 performs error diffusion processing.

A combining unit 227 can combine two received image data to generate an assembly of image data that constitute one frame. For example, to combine two image data, the combining unit 227 can use a method for calculating an average value of luminance values of the pixels to be combined as a combined luminance value or a method for designating a luminance value of a pixel that is brighter (or darker) in luminance level as a combined luminance value. Further, the combining unit 227 can perform an appropriate operation (e.g., OR operation, AND operation, or exclusive OR operation) between the pixels to be combined to determine a combined luminance value.

A thinning unit 226 can perform resolution conversion processing by thinning some pixels out of received image data to generate thinned-out image data that is ½, ¼, or ⅛ in resolution level. A moving unit 225 can add or delete a marginal portion to or from received image data.

A raster image processing (RIP) unit 228 can receive intermediate data generated based on PDL code data transmitted from a PC, and can generate bitmap data (multi-valued data). A compression unit 229 can compress the generated bitmap data (multi-valued data).

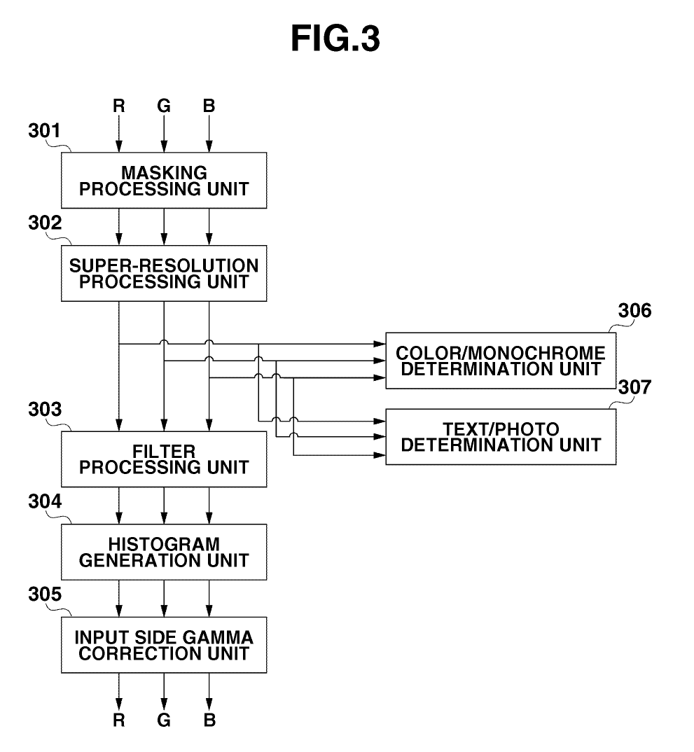

FIG. 3 is a block diagram illustrating an internal configuration of the scanner image processing unit 212. The scanner image processing unit 212 receives 8-bit luminance signals of R, G, and B colors as input image data. A masking processing unit 301 can convert the input luminance signal into a standard luminance signal that does not depend on a filter color of the CCD.

A super-resolution processing unit 302 can execute super-resolution processing on the image data received from masking processing unit 301. In general, copying machines and multifunction peripherals enable users to select a processing mode of the super-resolution processing via the operation unit 13. Details of the processing mode of the super-resolution processing are described below.

In the present exemplary embodiment, the area sensor is disposed in an inclined state to acquire a plurality of images that are shifted in phase in both the main scanning direction and the sub scanning direction for each of the R, G, and B channels. The area sensor is described below in more detail with reference to FIGS. 24A to 24D.

A filter processing unit 303 can arbitrarily correct the spatial frequency of the image data received from the super-resolution processing unit 302. The filter processing unit 303, for example, performs arithmetic processing on the received image data using a 7×7 matrix. In general, copying machines and multifunction peripherals enable users to select one of a text mode, a photo mode, and a text/photo mode, as a copy mode, via the operation unit 13.

If the operation unit 13 receives a user's selection of the text mode, the operation unit 13 transmits the selection information to the CPU 201 via the operation unit I/F 205. The CPU 201 controls the filter processing unit 303 to apply a text filter to the entire image data. If the mode selected by the user is the photo mode, the CPU 201 controls the filter processing unit 303 to apply a photo filter to the entire image data.

Further, if the mode selected by the user is the text/photo mode, the CPU 201 controls the filter processing unit 303 to adaptively switch between the text filter and the photo filter for each pixel according to a text/photo determination signal (part of attribute data) that is described below in more detail.

The photo filter is characteristic in setting filter coefficients that can effectively smooth only high frequency components to eliminate roughness of an image. The text filter is characteristic in setting filter coefficients that can intensify edges to increase sharpness of each character.

A histogram generation unit 304 can sample luminance data of respective pixels that constitute part of the image data received from the filter processing unit 303. More specifically, the histogram generation unit 304 sets a rectangular area including start and end points determined beforehand in both the main scanning direction and the sub scanning direction.

The histogram generation unit 304 samples luminance data in the designated rectangular area in both the main scanning direction and the sub scanning direction at constant pitches. Then, the histogram generation unit 304 generates histogram data based on a result of the sampling. The generated histogram data can be used to estimate a background level when the background color removal processing is performed.

An input side gamma correction unit 305 can convert the histogram data received from the histogram generation unit 304 into luminance data having nonlinear characteristics. To this end, the input side gamma correction unit 305 includes a table.

A color/monochrome determination unit 306 can determine whether each pixel constituting part of the image data received from the super-resolution processing unit 302 is a chromatic color or an achromatic color. The color/monochrome determination unit 306 associates a color/monochrome determination signal representing a determination result (i.e., part of attribute data) with image data.

A text/photo determination unit 307 can determine whether each pixel that constitutes part of the image data received from the super-resolution processing unit 302 is a pixel that constitutes a text, a pixel that constitutes a halftone dot, a pixel that constitutes a text included in a halftone dot image, or a pixel that constitutes a solid image, based on a pixel value of each pixel and a pixel value of a peripheral pixel neighboring each pixel.

Pixels other than the above-described pixels are regarded as white pixels that constitute a white area. The text/photo determination unit 307 associates a text/photo determination signal representing a determination result (i.e., part of attribute data) with image data.

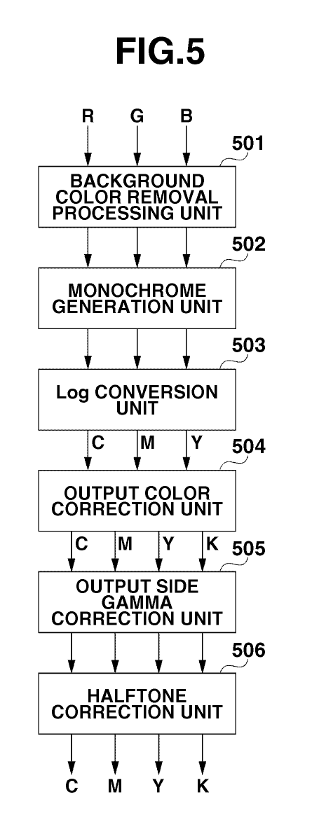

FIG. 5 is a block diagram illustrating an internal configuration of the printer image processing unit 215. A background color removal processing unit 501 can remove a background color of image data using a histogram generated by the scanner image processing unit 212.

A monochrome generation unit 502 can convert color data into monochrome data. A Log conversion unit 503 can perform luminance density conversion processing. For example, the Log conversion unit 503 converts input RGB image data into CMY image data.

An output color correction unit 504 can perform output color correction processing. For example, the output color correction unit 504 can convert input CMY image data into CMYK image data using a table or a matrix. An output side gamma correction unit 505 can correct a signal input to the output side gamma correction unit 505 to be proportional to a reflection density value of an output copy.

A halftone correction unit 506 can perform halftone processing according to a gradation number of an output destination (i.e., the printer unit). For example, the halftone correction unit 506 performs processing for converting received high-resolution image data into binary data or 32-valued data.

On the other hand, the scanner image processing unit 212 and the printer image processing unit 215 can directly output received image data without performing any processing on these data.

FIG. 24A illustrates an example of a configuration of the area sensor according to the present exemplary embodiment. In FIG. 24A, an area sensor device 2401 includes a plurality of pixel sensors 2402, which covers H pixels arranged in the longer-side direction and L pixels arranged in the shorter-side direction.

As a modified version of the present exemplary embodiment, the above-described pixel sensor corresponding to one pixel can be constituted by an assembly of three pixel sensors of R, G, and B colors. Further, the number of H pixels can be equalized with the number of L pixels. Namely, the length of the longer side can be set to be equal to the length of the shorter side. A distance N between centers of two neighboring pixel sensors substantially defines the resolution of the area sensor.

An area sensor usable for a high-resolution digital camera is constituted by numerous pixels as the number of pixel sensors in the longer-side direction and the number of pixel sensors in the shorter-side direction. For example, a digital camera of a 1.0×10⁷ pixels class includes 3,800 pixels serving as the pixel sensors in the longer-side direction and 2,800 pixels serving as the pixel sensors in the shorter-side direction.

In general, when an area sensor is incorporated in a camera, the area sensor captures an input image as image data extending in a two-dimensional area. More specifically, the area sensor uses numerous pixel sensors disposed in a two-dimensional pattern for each image capturing processing.

When the area sensor device 2401 is mounted on the scanner unit 11, accurately disposing the pixel sensors in both the horizontal direction and the vertical direction without causing any inclination is very important to obtain image data that can accurately represent a captured document image that is not distorted. Accordingly, if the pixel sensors are accurately disposed, a captured image can be precisely reproduced without causing any inclination.

For example, in a case where an area sensor is incorporated in a general camera, linearly disposed pixel sensors indicated by a black frame 2403 can obtain image data that constitute an uppermost end portion of a target image to be captured. In this case, a partial image to be reproduced based on the read image data is parallel to the horizontal direction (i.e., the longitudinal direction of the black frame 2403).

Similarly, linearly disposed pixel sensors indicated by a black frame 2404 can obtain image data of a portion different from the portion captured by the pixel sensors indicated by the black frame 2403. More specifically, the linearly disposed pixel sensors indicated by the black frame 2404 can obtain image data of a portion beneath the uppermost end portion in the vertical direction. Further, linearly disposed pixel sensors indicated by a black frame 2405 can obtain image data of a portion corresponding to the fifth line from the top in the vertical direction.

As described above, in a case where an area sensor is incorporated in a digital camera, the area sensor captures an image of a two-dimensional area as image data. Therefore, each of a plurality of pixel sensors that constitute the area sensor captures an image of a partial area of a target to be shot that is different from a partial area captured by another pixel sensor.

However, a method for using an area sensor incorporated in an apparatus according to the present exemplary embodiment is different from the above-described method for using an area sensor in the digital camera.

First, an example method includes mounting the area sensor illustrated in FIG. 24A on the scanner unit 11 at a reference setup position. In FIG. 1, when a document is placed on a document positioning plate (not illustrated) at a designated position, a light source travels in a direction parallel to the vertical direction of the document while emitting light toward the document. The area sensor receives reflection light from the document, without causing any inclination between the reflection light and the area sensor.

More specifically, pixel sensors disposed in the horizontal direction (i.e., the longer-side direction) illustrated in FIG. 24A can receive reflection light, as image data consisting of one line that can be obtained while the light source performs a horizontal scanning operation. Therefore, the sensor is set up to a position where a document image can be accurately obtained without causing any inclination.

As described above, the “reference setup position” of a sensor can be referred to as a setup position of the sensor where an output of a document image can be realized. In the following description, to simplify the description, it is supposed that the area sensor includes a plurality of pixel sensors whose dimensions are comparable to 20 pixels in the longer-side direction and comparable to 10 pixels in the shorter-side direction.

As a modified version of the present exemplary embodiment, a sensor size in the longer-side direction can be equalized with a sensor size in the shorter-side direction. The above-described number of pixel sensors is a mere example provisionally determined for the purpose of describing operations and structural features of the area sensor according to the present exemplary embodiment. Therefore, the number of pixel sensors is not limited to the illustrated example. It is needless to say that the number of pixel sensors is equal to the number of pixel sensors actually used in a digital camera.

The method includes driving a reading unit (not illustrated) that includes an area sensor incorporated in the scanner unit 11 to read an image of a document positioned on a document positioning plate. More specifically, the method includes performing a reading operation using a plurality of reading line sensors 2404 and 2405 (each being an assembly of linearly disposed pixel sensors) that can operate in the same manner as the above-described line sensor. The reading line sensors 2404 and 2405 can read a document image in the following manner.

FIG. 24B illustrates a document image to be read in the present exemplary embodiment. A grating illustrated in FIG. 24B represents the resolution of pixel sensors that constitute the reading line sensor 2404 or 2405. The direction indicated by an arrow (A) is a direction corresponding to the main scanning direction. The direction indicated by an arrow (B) is a direction corresponding to the sub scanning direction.

If the driven reading unit moves along a lower surface of the document positioning plate in the sub scanning direction, image data input via the reading line sensors 2404 and 2405 is successively read. More specifically, of the document image, a portion having a line width corresponding to the position of the reading unit is momentarily read.

When the reading unit moves along the lower surface of the document positioning plate in the sub scanning direction, a portion corresponding to a line width of the reading unit is irradiated with the light from the light source along the direction indicated by the arrow (B) from the top to the bottom of the document illustrated in FIG. 24B.

In this case, a reading position of image data to be read by the line sensor 2404 shifts from a reading position of image data to be read by the line sensor 2405, because the setup positions of two line sensors 2404 and 2405 are offset in the shorter-side direction.

Then, a document image read by each reading line sensor is regarded as independent image data. The portion corresponding to the line width is momentarily read when it is irradiated with the light. While the entire area of the target document is thoroughly irradiated with the light from the light source, each line sensor reads image data on the document at a corresponding position.

Then, the read image data are successively stored in the memory. FIGS. 24C and 24D illustrate two images acquired in the above-described manner, according to which two images shift from each other in the sub scanning direction by an amount corresponding to one pixel.

The image data mutually shifting in the sub scanning direction can be obtained as frame image data, the total number of which is equal to the number of line sensors that constitute the area sensor.

As described above, in a case where an area sensor includes numerous pixel sensors disposed in a two-dimensional pattern to read an image, one reading operation by the area sensor can obtain frame image data corresponding to a plurality of frames that continuously mutually shift in phase in the sub scanning direction.

Next, an example method for using the area sensor incorporated in an apparatus according to the present exemplary embodiment is described below.

First, the method according to the present exemplary embodiment includes inclining the orientation of a sensor body when the area sensor illustrated in FIG. 24A is mounted on the scanner unit 11. FIG. 20A illustrates an example of the inclined layout of the area sensor according to the present exemplary embodiment.

In FIG. 20A, an area sensor device 2001 includes numerous pixel sensors 2002 whose dimensions are comparable to 20 pixels in the longer-side direction and comparable to 10 pixels in the shorter-side direction.

In the mounting operation, the area sensor is inclined relative to the above-described reference setup position. More specifically, as illustrated in FIG. 20A, an angle θ is formed between the lowermost edge of the area sensor device 2001 and the line representing the reference setup position.

To define the position of each pixel sensor constituting the area sensor, it is presumed that the origin is positioned at the upper left edge of the area sensor. Further, the x direction is parallel to the longer-side direction and the y direction is parallel to the shorter-side direction. More specifically, the pixel sensor positioned at the upper left edge of the area sensor device 2001 can be expressed using coordinate values (x, y)=(0, 0). The pixel sensor positioned at the upper right edge of the area sensor device 2001 can be expressed using coordinate values (x, y)=(19, 0).

Similarly, the pixel sensor positioned at the lower left edge of the area sensor device 2001 can be expressed using coordinate values (x, y)=(0, 9), and the pixel sensor positioned at the lower right edge of the area sensor device 2001 can be expressed using coordinate values (x, y)=(19, 9).

A reading line sensor 2003 (i.e., an assembly of linearly disposed pixel sensors) constitutes one line of the area sensor device 2001. More specifically, the reading line sensor 2003 includes 20 pixel sensors that are linearly disposed in the longer-side direction.

More specifically, the reading line sensor 2003 is composed of a total of 20 pixel sensors having coordinate values (0, 4), (1, 4), (2, 4), . . . , and (19, 4). Similarly, a reading line sensor 2004 is composed of 20 pixel sensors having coordinate values (0, 5), (1, 5), (2, 5), . . . , and (19, 5).

In the present exemplary embodiment, the reading unit including the area sensor mounted on the scanner unit 11 is driven in the sub scanning direction to read an image of a document placed on the document positioning plate. More specifically, each of the reading line sensors 2003 and 2004 (each being an assembly of pixel sensors) can be used to perform a reading operation that is similar to the operation performed by an independent line sensor as described above.

Next, an example of a document image reading operation that can be performed by the reading line sensor 2003 and the reading line sensor 2004 is described below. It is presumed that the document image to be read by the reading line sensors 2003 and 2004 is the above-described image illustrated in FIG. 24B. Further, it is presumed that the grating illustrated in FIG. 24B represents the resolution of pixel sensors that constitute the reading line sensor 2003 or 2004.

Although an image of the document can be read in the manner described above, the image data obtained in this case reflects the inclination of the area sensor that corresponds to the angle θ formed between the lowermost edge of the area sensor device 2001 and the line representing the reference setup position.

FIGS. 20B and 20C illustrate image data acquired by the line sensors 2003 and 2004, respectively, which are inclined by the angle θ. In this case, in FIGS. 20B and 20C, the direction indicated by the arrow (a) is the main scanning direction and the direction indicated by the arrow (b) is the sub scanning direction.

On the other hand, the direction indicated by an arrow (c) is the horizontal direction of the read image data. Further, the direction indicated by an arrow (d) is the vertical direction of the read image data. As illustrated in FIG. 20A, the reading line sensor 2003 and the reading line sensor 2004 shift from each other in the shorter-side direction by an amount corresponding to one pixel sensor.

Accordingly, the pixel sensors that constitute the reading line sensor 2003 and the pixel sensors that constitute the reading line sensor 2004 shift in phase in the shorter-side direction. For example, the pixel sensor of the reading line sensor 2003 positioned at the coordinate point expressed by (x, y)=(15, 4) shifts from the pixel sensor of the reading line sensor 2004 positioned at the coordinate point expressed by (x, y)=(15, 5) by an amount y=1 in the y-axis direction (i.e., the shorter-side direction). The shift (y=1) in the y-axis direction causes a shift Δβ in the sub scanning direction.

On the other hand, two pixel sensors do not shift from each other in the x-axis direction (i.e., the longer-side direction) because the x-coordinate value is the same (x=15). However, the inclination angle θ causes a significant shift in phase between two pixel sensors in the main scanning direction that is parallel to the line representing the reference setup position, by a small amount Δα, which corresponds to the size of a sub pixel.

More specifically, even when pixel sensors of two reading line sensors are identical to each other in position in the x-axis direction (i.e., the longer-side direction), a small amount of phase shift is generated if the area sensor is inclined.

The phase shift generated in this manner is dependent on the inclination angle θ. Accordingly, when image data is read by a plurality of reading line sensors that define an area sensor, the read two pieces of image data are differentiated from each other in phase shift. More specifically, the image data read by the line sensor 2003 illustrated in FIG. 20B and the image data read by the line sensor 2004 illustrated in FIG. 20C mutually shift in phase not only in the sub scanning direction by the amount Δβ but also in the main scanning direction by the amount Δα.

In the above-described description, only two reading line sensors (i.e., the reading line sensors 2003 and 2004) are used. However, the number of the reading line sensors is not limited to only two. As another version of the present exemplary embodiment, the number of pixel sensors in the x-axis direction that constitute an area sensor can be increased to provide numerous reading line sensors.

More specifically, an area sensor can include a plurality of reading line sensors whose number is comparable to the number of pixels arranged in the x-axis direction. The total number of the reading line sensors is equal to the number of frames to be obtained during one reading operation.

For example, in a case where an area sensor includes reading line sensors corresponding to 30 lines, respective line sensors can obtain image data that correspond to 30 frames and have unique phase shifts during one reading operation.

Inclining the area sensor in a manner described above enables to obtain image data of a plurality of frames, in which a positional shift between two document images read by neighboring sensors in the shorter-side direction is less than one pixel, during one scanning processing on the document.

Further, as another version of the present exemplary embodiment, the area sensor can be installed in such a manner that the longer-side direction becomes parallel to the horizontal direction at the reference setup position and the shorter-side direction is inclined relative to the reference setup position.

In this case, similar to FIG. 20A, during one scanning processing on a document, two neighboring sensors disposed in the shorter-side direction can obtain two pieces of frame image data that mutually shift in position by an amount less than one pixel in the main scanning direction and/or in the sub scanning direction.

More specifically, the present exemplary embodiment can employ any other area sensor including a plurality of sensors that can obtain frame image data in a case where a scanning position moves horizontally relative to a document to be read, in which a first sensor and a second sensor that are positioned next to each other in the shorter-side direction mutually shift in a reading position by an amount less than one pixel in the main scanning direction and/or in the sub scanning direction.

Further, the inclination angle θ of the area sensor illustrated in FIG. 20A can be set to any angle that can satisfy the condition that two neighboring sensors disposed in the shorter-side direction can obtain frame image data whose positional shift is within one pixel in the main scanning direction and/or in the sub scanning direction, during one scanning processing on a document.

Further, the number of acquisitions of frame image data to be obtained in the shorter-side direction of the sensor can be increased by increasing the number of document image reading operations in the sub scanning direction or by increasing the number of sampling operations per unit time.

An example setting of a processing mode for the super-resolution processing according to the present exemplary embodiment is described below. In the following description, “frame image data” represents data having been read during scanning of a document image configured by one screen (frame). The “frame image data” is data constituting a document image that corresponds to one screen (frame).

The image processing apparatus according to the present exemplary embodiment can acquire frame image data by an amount equivalent to 100 frames when the area sensor reads a document image at a low resolution level comparable to 100 dpi. Further, in the super-resolution processing, the image processing apparatus according to the present exemplary embodiment can generate a high resolution image of 200 dpi if the usable amount of low-resolution frame image data is comparable to four frames.

The image processing apparatus can generate a high resolution image of 300 dpi if the usable amount of low-resolution frame image data is comparable to 10 frames. Further, the image processing apparatus can generate a high resolution image of 600 dpi if the usable amount of low-resolution frame image data is comparable to 40 frames. Further, the image processing apparatus can generate a high resolution image of 1200 dpi if the usable amount of low-resolution frame image data is comparable to 100 frames. Further, the low resolution level is not limited to 100 dpi and can be any other resolution level that is set by each apparatus for an ordinary image output operation.

Further, image data received by the scanner image processing unit 212 include bitmap data of an actual document image and attribute information that indicates an attribute of each pixel that constitutes the document image. The attributes of the pixels are classified into three types, i.e., “text”, “graphics”, and “image.”

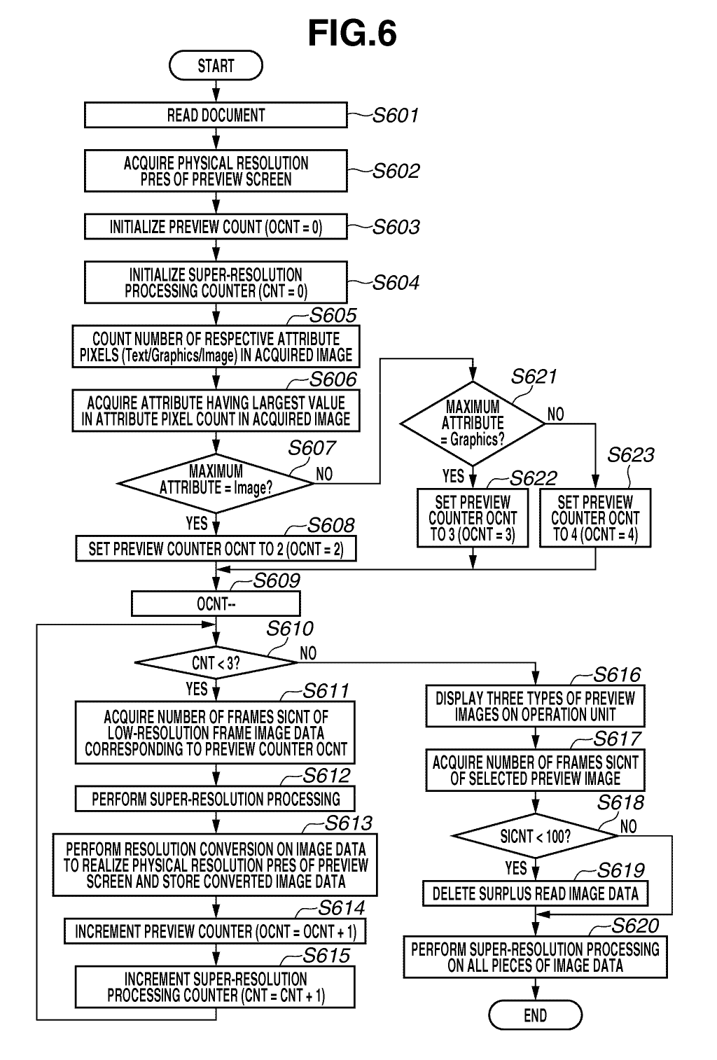

FIG. 6 is a flowchart illustrating an example procedure of super-resolution processing mode setting processing that can be performed by the controller 20 of the image processing apparatus. To realize the processing illustrated in FIG. 6, an appropriate control program is stored in the ROM 203 as described above and can be executed by the CPU 201.

First, in step S601, the CPU 201 causes the scanner unit 11 to perform a document reading operation. The scanner image processing unit 212 receives image data of the read document via the scanner I/F 211 and directly sends the read document image data to the HDD 204 without performing any processing on the image data. Next, in step S602, the CPU 201 acquires a physical resolution PRES of a preview screen to be displayed by the operation unit 13. Next, in step S603, the CPU 201 initializes a preview counter OCNT (i.e., OCNT=0). In step S604, the CPU 201 initializes a super-resolution processing counter CNT (i.e., CNT=0).

Next, in step S605, the CPU 201 reads the first frame of the image input by the scanner unit 11 from the HDD 204. The CPU 201 determines an attribute of each pixel and counts the number of pixels having an image attribute, the number of pixels having a text attribute, and the number of pixels having a graphics attribute.

Then, in step S606, the CPU 201 identifies the attribute that is largest in the counted number of pixels as a feature representing the input image. The CPU 201 determines a resolution suitable for the identified attribute of the input image. The CPU 201 performs the following processing to generate an output image having the determined resolution.

Next, in step S607, if it is determined that the attribute information acquired in step S606 is the image attribute, then in step S608, the CPU 201 sets the preview counter OCNT to 2 (i.e., OCNT=2). Then, in step S609, the CPU 201 decrements the preview counter OCNT by one. When the preview counter OCNT is decremented by one, an output image to be displayed in a preview has a resolution that is lower by one level than the resolution suitable to the attribute.

Next, in step S610, the CPU 201 compares the super-resolution processing counter CNT with a threshold value 3. In the present exemplary embodiment, the threshold value 3 is set to perform three types of super-resolution processing for preview image data to be displayed on the operation unit 13. If it is determined that the super-resolution processing counter CNT is less than the threshold value 3 (YES in step S610), then in step S611, the CPU 201 acquires a number of frames SICNT of low-resolution frame image data corresponding to the preview counter OCNT. In the present exemplary embodiment, a correspondence information table defining a relationship between the preview counter OCNT and the number of frames SICNT at each output resolution is stored in the ROM 203.

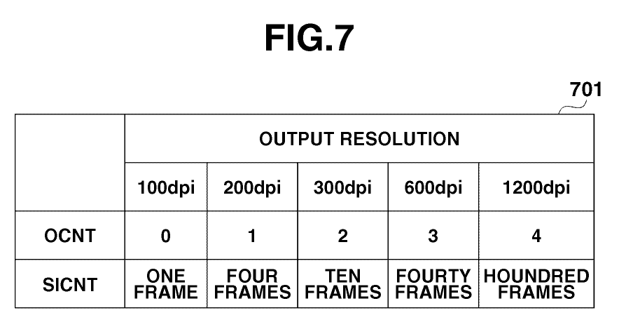

FIG. 7 illustrates an example of the correspondence table stored in the ROM 203, which defines a relationship between the preview counter OCNT and the number of frames SICNT at each output resolution. For example, in a case where the preview counter value is 2 (OCNT=2), a desired output resolution is 300 dpi. In this case, an amount of low-resolution frame image data required to acquire an image of 300 dpi is comparable to 10 frames.

Setting of resolution levels in the correspondence table is stepwise (e.g., 100 dpi, 200 dpi, 300 dpi, 600 dpi, and 1200 dpi). The stepwise resolution levels suitable for outputting an image having an image attribute, an image of a text attribute, and an image having a graphics attribute can be experimentally obtained.

Further, a resolution suitable for outputting an image having a predetermined attribute can be experimentally determined by human eyes. For example, in a case where the attribute of an input image is TEXT (OCNT=4), recognition of this image is easier for human eyes when the resolution of an output image is high. Accordingly, the CPU 201 automatically determines that a desired output resolution level is 600 dpi.

On the other hand, in a case where the attribute of an input image is IMAGE (OCNT=2), the resolution of an output image needs not to be high. Accordingly, in this case, the CPU 201 automatically determines that a desired output resolution level is 200 dpi.

Further, the correspondence table can be prepared beforehand considering performances of each device. Accordingly, it is needless to say that there may be a device that requires frame image data by an amount corresponding to 100 frames if the resolution of an output image is 600 dpi. Another device may require frame image data corresponding to 40 frames to output an image of 1200 dpi. Therefore, the correspondence table is variable in its contents depending on each device. Further, the contents of the correspondence table can be arbitrarily changed by each user.

Next, in step S612, the CPU 201 performs super-resolution processing (first high resolution conversion processing) on a target partial area of the frame image data of the low-resolution image whose frame amount was acquired in step S611.

Then in step S613, the CPU 201 performs resolution conversion processing on the image data to realize the physical resolution PRES of the preview screen and stores the converted image data. An example partial area extraction method is described below. For example, simple thinning processing or filter processing can be used as a method for performing resolution conversion on image data to realize the physical resolution PRES of the preview screen.

Next, in step S614, the CPU 201 increments the preview counter OCNT by one. Further, in step S615, the CPU 201 increments the super-resolution processing counter CNT by one. Then, the processing returns to step S610.

Then, in step S611, the CPU 201 selects a resolution higher by one level than the previous resolution in the correspondence table illustrated in FIG. 7 according to the incremented value of the super-resolution processing counter OCNT and determines a number of frames SICNT required to realize the selected resolution. Then, the CPU 201 repeats the above-described processing in steps S613 to S615 using the determined number of frames SICNT.

By repeating the processing of steps S611 to S615 three times, the CPU 201 determines a plurality of resolution values of the images to be previewed, and determines a plurality of values with respect to the number of frames of the frame image data to output an image having a determined resolution. Then, the CPU 201 generates three types of preview images by performing super-resolution processing using the above-described frames.

On the other hand, if it is determined that the super-resolution processing counter CNT is equal to or greater than the threshold value 3 (NO in step S610), the CPU 201 determines that three types of preview super-resolution processing have been completed. Then, in step S616, the CPU 201 displays three types of preview images on a display unit of the operation unit 13.

In this case, the CPU 201 displays the number of frames SICNT acquired in step S611 together with size information of image data required in the processing. The size of the image data required in the processing is equal to A×SICNT (Byte) when “A” (Byte) represents a data size of low-resolution frame image data that constitute one frame.

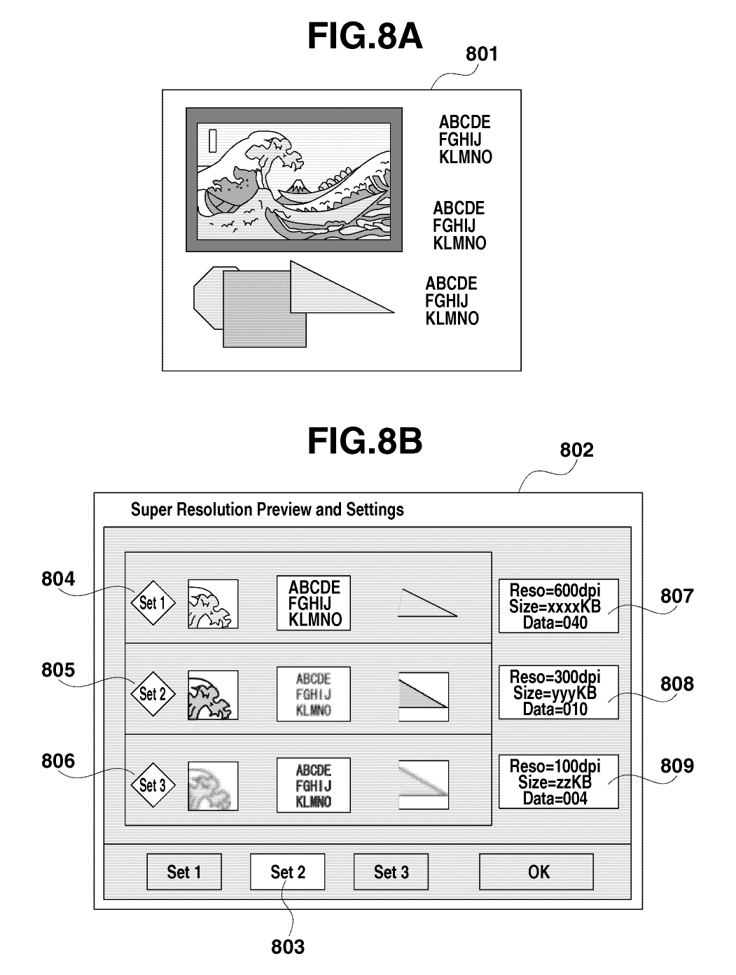

FIG. 8A illustrates an input document 801. FIG. 8B illustrates a selection screen 802 displayed on the operation unit 13, which includes preview images that are actually generated through the super-resolution processing. A user can operate the operation unit 13 to set an output image while viewing the preview images having been subjected to the super-resolution processing. In FIGS. 8A and 8B, image attribute information is maximized.

The selection screen 802 includes a preview “Set 1” 804 that is a preview image corresponding to a case where the super-resolution processing counter OCNT is largest (i.e., OCNT=3). The output resolution of the preview image “Set 1” 804 is 600 dpi and the number of frames SICNT is 40 frames. The preview image “Set 1” 804 includes samples of partial preview images (e.g., an image portion, a text portion, and a graphics portion) of an input image, which are arranged from left to right, as output images having a resolution of 600 dpi. Further, the preview image “Set 1” 804 is associated with additional data 807 relating to an output operation according to the preview image “Set 1”, which includes output resolution information and data size information.

Similarly, the selection screen 802 includes a preview image “Set 2” 805 that is a preview image corresponding to a case where the super-resolution processing counter OCNT is medium (i.e., OCNT=2). The preview image “Set 2” 805 is associated with additional data 808 relating to an output operation according to the preview image “Set 2.”

Moreover, the selection screen 802 includes a preview image “Set 3” 806 that is a preview image corresponding to a case where the super-resolution processing counter OCNT is smallest (i.e., OCNT=1). The preview image “Set 3” 806 is associated with additional data 809 relating to an output operation according to the preview image “Set 3.”

As described above, an image having a desired resolution that is determined according to an attribute, an image having a resolution lower by one level than the desired resolution, and an image having a resolution higher by one level than the desired resolution can be previewed together. Therefore, users can select a desirable image from the preview samples.

The above-described resolution higher by one level can be regarded as a resolution higher by one level than a specific resolution that is determined as desirable, based on a result of analysis, among the stepwise resolution levels set in the correspondence table illustrated in FIG. 7. The above-described one level is a value that can be experimentally set beforehand, as described above.

Similarly, the above-described resolution lower by one level can be regarded as a resolution lower by one level than a specific resolution that is determined as desirable, based on a result of analysis, among the stepwise resolution levels set in the correspondence table illustrated in FIG. 7. The above-described one level is a value that can be experimentally set beforehand, as described above.

Therefore, in a case where an image having an automatically analyzed desired resolution is not satisfactory for a user, the user can select another output image referring to preview samples of images having another resolution values. According to the example illustrated in FIG. 8B, a “Set 2” button 803 is pressed by the user to select the preview image “Set 2” from the selection screen 802.

Next, in step S617, the CPU 201 acquires a number of frames SICNT that corresponds to the preview counter OCNT from the operation unit 13 via the operation unit I/F 205 in response to user's selection of the preview image. In step S618, the CPU 201 compares the acquired number of frames SICNT with a maximum acquisition number of frames (=100).

If it is determined that the number of frames SICNT is less than the maximum acquisition number of frames (=100) (YES in step S618), then in step S619, the CPU 201 deletes the surplus of read image data. Next, in step S620, the CPU 201 performs super-resolution processing (second high resolution conversion processing) on all pieces of image data and terminates the processing routine illustrated in FIG. 6.

On the other hand, if it is determined that the attribute information acquired in step S606 is the graphics attribute (YES in step S621), then in step S622, the CPU 201 sets the preview counter OCNT to 3 (i.e., OCNT=3). Then, the processing proceeds to step S609. On the other hand, if it is determined that the attribute information acquired in step S606 is the text attribute (NO in step S607 and NO in step S621), then in step S623, the CPU 201 sets the preview counter OCNT to 4 (i.e., OCNT=4). Then, the processing proceeds to step S609.

As described above, compared to a case where a larger part of an input image has the image attribute, each of a graphics attribute image and a text attribute image requires a higher output resolution and, therefore, a numerical value of the preview counter OCNT becomes larger.

The document reading processing to be performed in step S611 of FIG. 6 is described below in more detail. In the present exemplary embodiment, an acquisition number of frames is determined by controlling an area of the above-described area sensor to be used.

In the present exemplary embodiment, the area sensor illustrated in FIG. 20A can be divided into 100 blocks each serving as a line sensor in the sub scanning direction, to acquire 100-dpi images consisting of 100 frames at maximum.

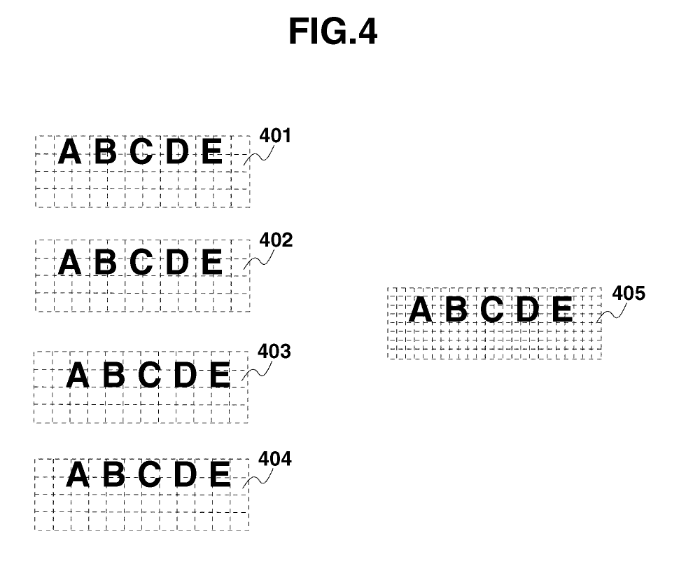

In the super-resolution processing, high-resolution image data can be generated using frame image data of a plurality of low-resolution images that mutually shift in phase by an amount less than one pixel in the main scanning direction and in the sub scanning direction for each of R, G, and B channels as illustrated in FIG. 4. Further, in the following description, the term “phase” represents a position of a pixel read from a document image. Further, the term “phase shift” indicates a shift of a pixel to be read.

For example, in the super-resolution processing, high resolution data can be obtained by extracting, from a plurality of continuous images, the one whose shift amount relative to a reference image is close to a position of pixel data required in the super-resolution processing, and then successively performing interpolation processing and mixing processing.

Example images 401 to 404 are obtainable from four pieces of image data that are mutually shifted by an amount equivalent to half of a pixel. These images are usable to obtain a high resolution image having a pixel density that is four times the pixel density of an original image 405.

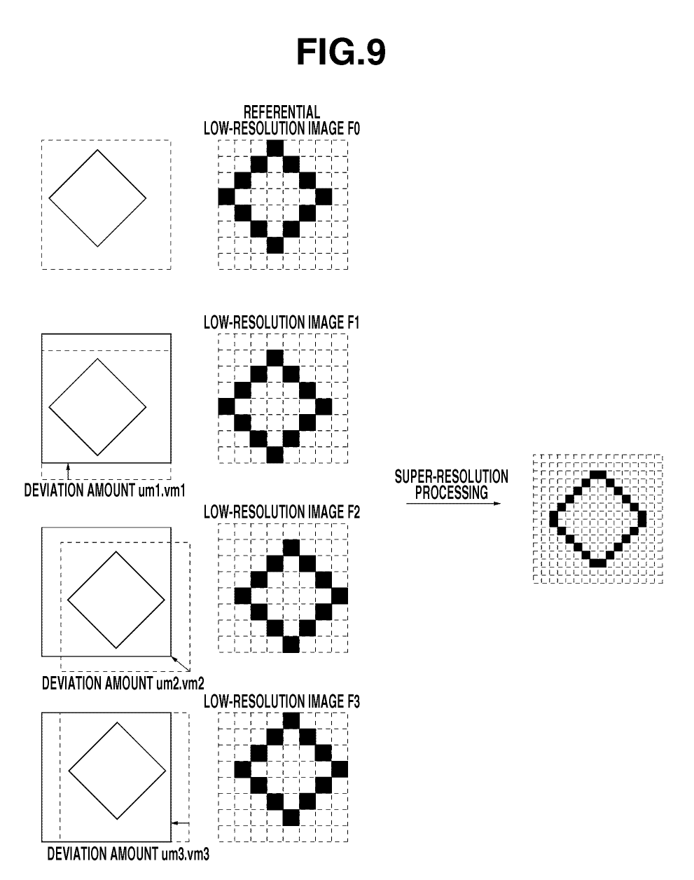

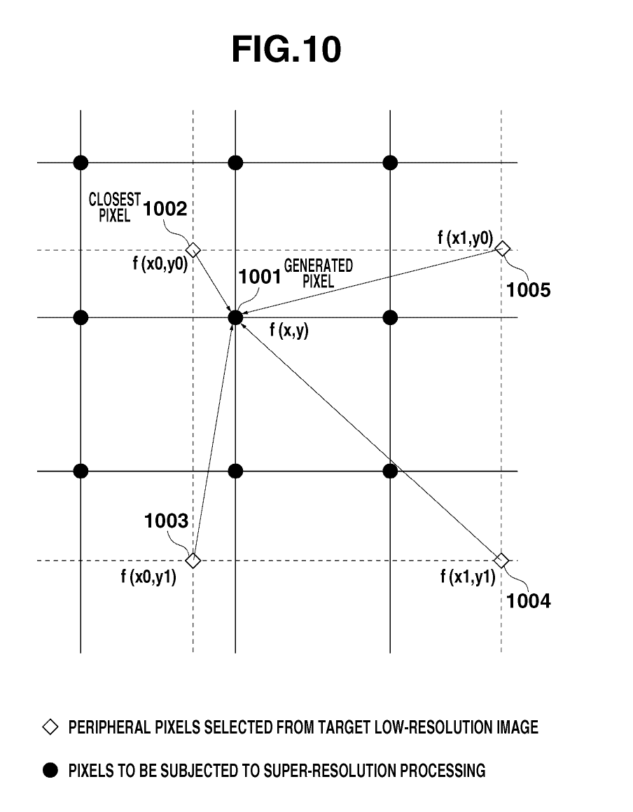

The super-resolution processing according to the present exemplary embodiment is described in more detail with reference to FIGS. 9 and 10.

FIG. 9 illustrates low-resolution images to be used in the super-resolution processing and an image having been subjected to the super-resolution processing. FIG. 9 illustrates a relationship between a document and a reference low-resolution image F0 of the document read by the area sensor. Similarly, FIG. 9 illustrates a relationship between the document and each of target low-resolution images F1 to F3.

A rectangular frame indicated by a dotted line is an area of the document read by the area sensor to obtain the reference low-resolution image F0. A rectangular frame indicated by a solid line is an area of the document read by the area sensor to obtain respective target low-resolution images F1 to F3.

In the present exemplary embodiment, “um” represents a shift amount in the main scanning direction and “vm” represents a shift amount in the sub scanning direction. Further, “umn” and “vmn” represent shift amounts of each target low-resolution image Fn (n=1 to 3). For example, as illustrated in FIG. 9, the target low-resolution image F1 shifts from the reference low-resolution image F0 in the sub scanning direction by the shift amounts “um1” and “vm1.” The target low-resolution image F2 shifts from the reference low-resolution image F2 in both the main scanning direction and the sub scanning direction by the shift amounts “um2” and “vm2.” Further, the target low-resolution image F3 shifts from the reference low-resolution image F0 in the main scanning direction by the shift amounts “um3” and “vm3.”

The shift amounts “umn” and “vmn” of each target low-resolution image Fn (n=1 to 3) can be calculated based on the image data of the reference low-resolution image F0 and the image data of respective target low-resolution images F1 to F3. In the calculation, inclination information of the area sensor stored in the ROM 203 can be used.

To simplify the description of the present exemplary embodiment, according to the example illustrated in FIG. 9, the shift amount between two target low-resolution images F1 and F2 is equal to one pixel and the shift amount between two target low-resolution images F2 and F3 is equal to one pixel.

However, in an actual reading operation by the area sensor, a smaller phase shift that is less than one pixel is caused in the main scanning direction and in the sub scanning direction. Such a smaller phase shift can be used to obtain a high resolution image.

Accordingly, among a plurality of pixels that constitute a super-resolution processed image (hereinafter, referred to as a “generated pixel”), some pixels are not present in the reference low-resolution image and in each target low-resolution image.

If such a generated pixel is present, it is useful to perform predetermined interpolation processing using pixel data representing pixel values of peripheral pixels that are present in the vicinity of the generated pixel. Then, a high resolution image can be obtained by performing mixing processing. For example, a bi-linear interpolation method, a bi-cubic interpolation method, or a nearest neighbor interpolation processing can be used. An example of the above-described processing is described below with reference to FIG. 10.

For example, the bi-linear interpolation method includes extracting a closest pixel 1002 that is closest to a generated pixel 1001 from the reference low-resolution image and each target low-resolution image. The bi-linear interpolation method further includes determining four pixels of the target low-resolution image that surround the position of the generated pixel as peripheral pixels 1002 to 1005, and obtaining a data value of the generated pixel according to the following formula (1) by averaging weighted data values representing the peripheral pixels.

$$f ( x , y ) = \frac{[ \vert x 1 - x \vert \{ \vert y 1 - y \vert f ( x 0 , y 0 ) + \vert y - y 0 \vert f ( x 0 , y 1 ) \} + \vert x - x 0 \vert \{ \vert y 1 - y \vert f ( x , y 0 ) + \vert y - y 0 \vert f ( x 1 , y 1 ) \} ]}{\vert x 1 - x 0 \vert \vert y 1 - y 0 \vert} \qquad ( 1 )$$

For example, the super-resolution image illustrated in FIG. 9, which has a doubled resolution value, can be obtained by repeating the above-described processing for each generated pixel position. In this case, the target resolution value can be set to an arbitrary value other than the doubled resolution value. Further, it is useful to use data values of a plurality of low-resolution images in the interpolation processing to obtain a highly accurate super-resolution image.

An example of partial area extraction processing, which is required to perform the super-resolution processing in step S612 of FIG. 6, is described below. A preview display of a partial area is effective to improve the processing efficiency, compared to a preview display of the entire area. The partial area to be previewed can be a smaller area as long as users can recognize the quality of an output image based on the preview image.

It is generally useful to select a characteristic area of an image as a partial area to be previewed. An example method for selecting the above-described characteristic area is described below.

The characteristic area selection method according to the present exemplary embodiment includes calculating an attribute value of each pixel in a block that constitutes part of low-resolution frame image data constituting one frame received from the scanner unit 11 via the scanner I/F 211.

The method further includes evaluating calculation results in respective blocks, and identifying a block which has a largest value with respect to each attribute, and finally determining a partial area to be previewed for each attribute as a representative area selected from all pieces of image data.

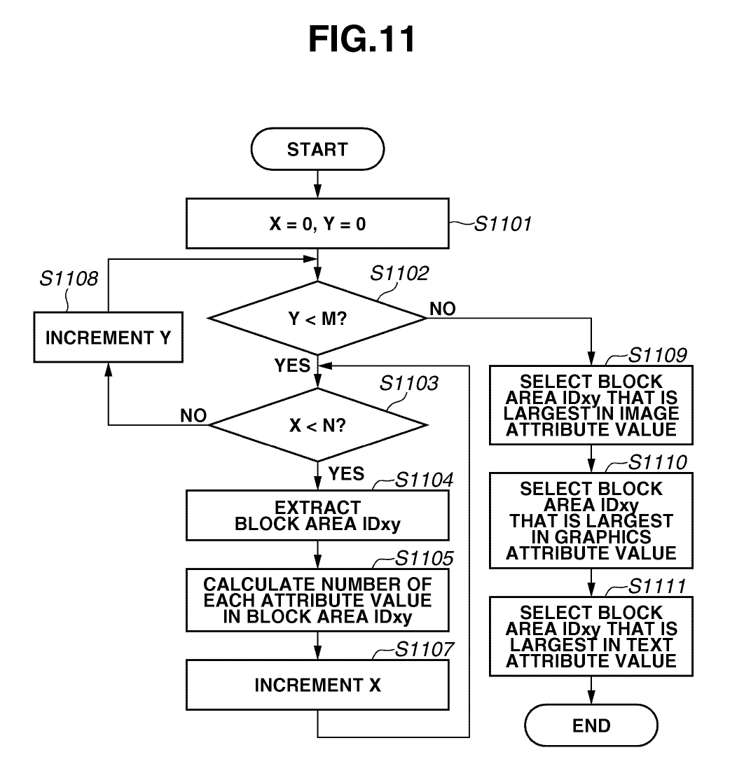

FIG. 11 is a flowchart illustrating an example procedure of the partial area extraction processing that can be performed by the controller 20 of the image processing apparatus. To realize the processing illustrated in FIG. 11, an appropriate control program is stored in the ROM 203 as described above and can be executed by the CPU 201. In the present exemplary embodiment, the CPU 201 divides image data into N×M blocks to perform partial area extraction processing.

First, in step S1101, the CPU 201 initializes a main scanning counter X and a sub scanning counter Y. Then, in step S1102, the CPU 201 compares the sub scanning counter Y with a threshold value M. If it is determined that the sub scanning counter Y is less than the threshold value M (YES in step S1102), then in step S1103, the CPU 201 compares the main scanning counter X with a threshold value N. If it is determined that the main scanning counter X is less than the threshold value N (YES in step S1103), then in step S1104, the CPU 201 extracts a block area IDxy.

Next, in step S1105, the CPU 201 calculates the number of each attribute value from the attribute data included in the block area IDxy extracted in step S1104, for each pixel. Through the processing performed in step S1105, the CPU 201 can generate a histogram with respect to an image attribute value, a graphics attribute value, and a text attribute value in the block area IDxy.

Next, in step S1107, the CPU 201 increments the main scanning counter X by one. The processing then returns to step S1103. If it is determined that the main scanning counter X is equal to or greater than the threshold value N (NO in step S1103), then in step S1108, the CPU 201 increments the sub scanning counter Y by one. The processing then returns to step S1102.

If it is determined that the sub scanning counter Y is equal to or greater than the threshold value M (NO in step S1102), then in step S1109, the CPU 201 determines that the processing of all blocks has been completed and selects a block area IDxy that is largest in the image attribute value among the N×M blocks.

Similarly, in step S1110, the CPU 201 selects a block area IDxy that is largest in the graphics attribute value among the N×M blocks. Further, in step S1111, the CPU 201 selects a block area IDxy that is largest in the text attribute value among the N×M blocks. Finally, the CPU 201 terminates the processing routine illustrated in FIG. 11.

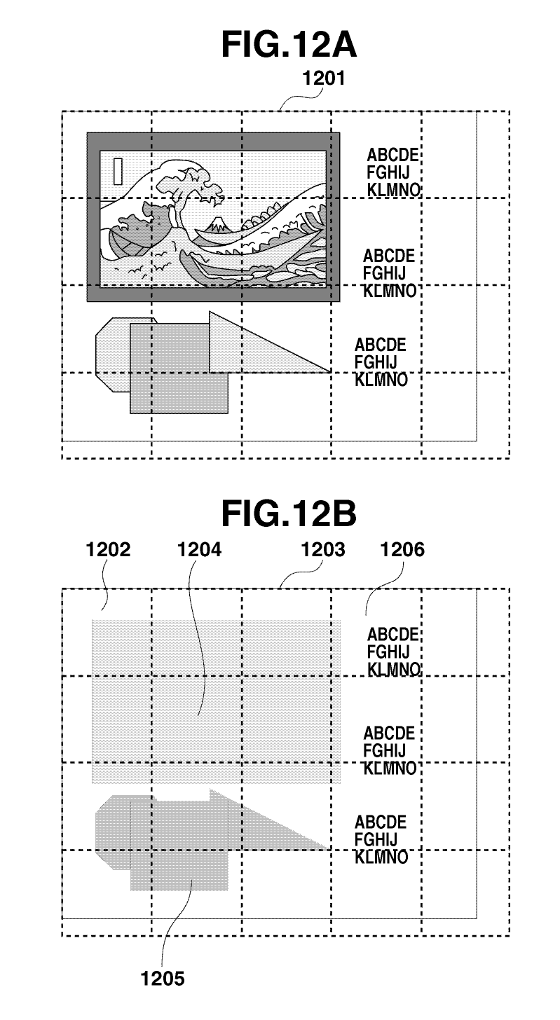

FIGS. 12A and 12B illustrate an example of the above-described processing, in which attribute data 1203 illustrated in FIG. 12B corresponds to an image data 1201 illustrated in FIG. 12A. The CPU 201 divides the image into N×M blocks and calculates a histogram of each attribute value in each block area IDxy 1202.

More specifically, the CPU 201 identifies a block in which the number of pixels having the text attribute is largest, a block in which the number of pixels having the image attribute is largest, and a block in which the number of pixels having the graphics attribute is largest.

According to the example illustrated in FIG. 12B, the CPU 201 extracts a block area 1204 as an area in which the number of the image attribute pixels is largest. The CPU 201 extracts a block area 1205 as an area in which the number of the graphics attribute pixels is largest. Further, the CPU 201 extracts a block area 1206 as an area in which the number of the text attribute pixels is largest.

Through the above-described processing, the present exemplary embodiment can identify attribute information of input image data and extract features of the image data. Further, the present exemplary embodiment can automatically determine a desired resolution value to output an image having the extracted features.

Then, the present exemplary embodiment can perform a preview display of a partial area of an output image in a case where the super-resolution conversion is performed to output an image having a determined resolution as well as in a case where the super-resolution conversion is performed to output an image having a higher resolution increased by one level and another image having a lower resolution reduced by one level.

Further, the present exemplary embodiment can display a numerical value indicating a data amount in addition to an image. Therefore, users can simply obtain a desired super-resolution output considering both image quality to be realized and the data amount.

The above-described first exemplary embodiment is characteristic in identifying attribute information of input image data and extracting features of image data, and is further characteristic in automatically performing a preview display of a partial area processed by the super-resolution processing so as to realize a desired resolution. A second exemplary embodiment of the present invention is characteristic in acquiring frequency characteristics of input image data to extract features of image data.

In the second exemplary embodiment, the controller 20 of the image processing apparatus calculates spatial frequency characteristics of the entire image data. If input image data include a large amount of higher frequency components, the controller 20 determines that a largest part of the image data is occupied by an image having the text attribute and identifies that the largest attribute value is the text attribute.

Similarly, if input image data include a large amount of lower frequency components, the controller 20 determines that a largest part of the image data is occupied by an image having the image attribute and identifies that the largest attribute value is the image attribute. In this manner, the controller 20 of the image processing apparatus acquires attribute information of input image data.

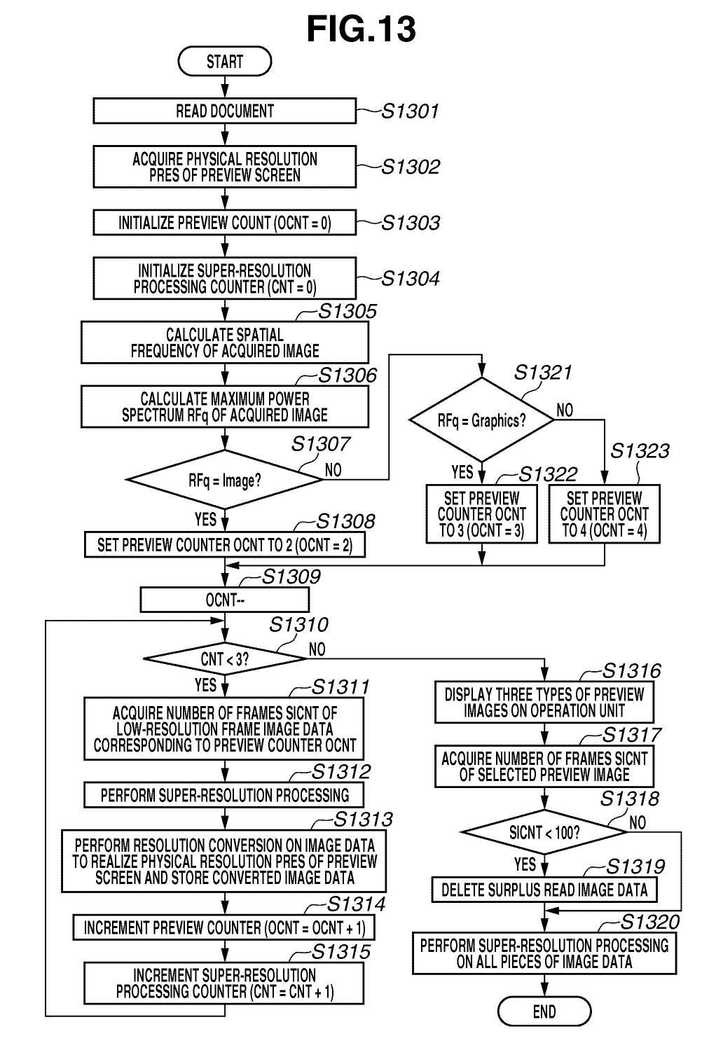

In the following description, processing similar to that described in the first exemplary embodiment is denoted by the same reference numeral and the description for the same is not repeated. FIG. 13 is a flowchart illustrating another example of the super-resolution processing mode setting processing that can be performed by the controller 20 of the image processing apparatus.

To realize the processing illustrated in FIG. 13, an appropriate control program is stored in the ROM 203 as described above and can be executed by the CPU 201. Further, processing to be performed in steps S1301 through S1304, processing to be performed in steps S1308 through S1320, and processing to be performed in steps S1322 and S1323 are similar to the processing described in the first exemplary embodiment with reference to FIG. 6.

In step S1305, the CPU 201 calculates a spatial frequency of the input image on the first frame acquired by the scanner unit 11 in step S1304. The CPU 201 performs calculation processing in the following manner.

Next, in step S1306, the CPU 201 calculates a maximum power spectrum RFq of the input image. Next, in step S1307, the CPU 201 compares the maximum power spectrum RFq acquired in step S1306 with an attribute determination threshold. If it is determined that a comparison result with respect to the maximum power spectrum RFq reveals an image attribute (YES in step S1307), then in step S1308, the CPU 201 sets the preview counter OCNT to 2 (i.e., OCNT=2). Next, in step S1309, the CPU 201 decrements the preview counter OCNT by one.

On the other hand, if the result of the comparison between the maximum power spectrum RFq and the attribute determination threshold acquired in step S1306 reveals a graphics attribute (YES in step S1321), then in step S1322, the CPU 201 sets the preview counter OCNT to 3 (i.e., OCNT=3). Then, the processing proceeds to step S1309.

On the other hand, if the result of the comparison between the maximum power spectrum RFq and the attribute determination threshold acquired in step S1306 reveals a text attribute (NO in step S1307 and NO in step S1321), then in step S1323, the CPU 201 sets the preview counter OCNT to 4 (i.e., OCNT=4). Then, the processing proceeds to step S1309.

An example of the input image spatial frequency calculation processing to be performed in step S1305 of FIG. 13 is described below in more detail. In the present exemplary embodiment, the CPU 201 calculates a spatial frequency of low-resolution frame image data that constitute one frame, which was received from the scanner unit 11 via the scanner I/F 211 and directly stored in the HDD 204 without being processed by the scanner image processing unit 212.

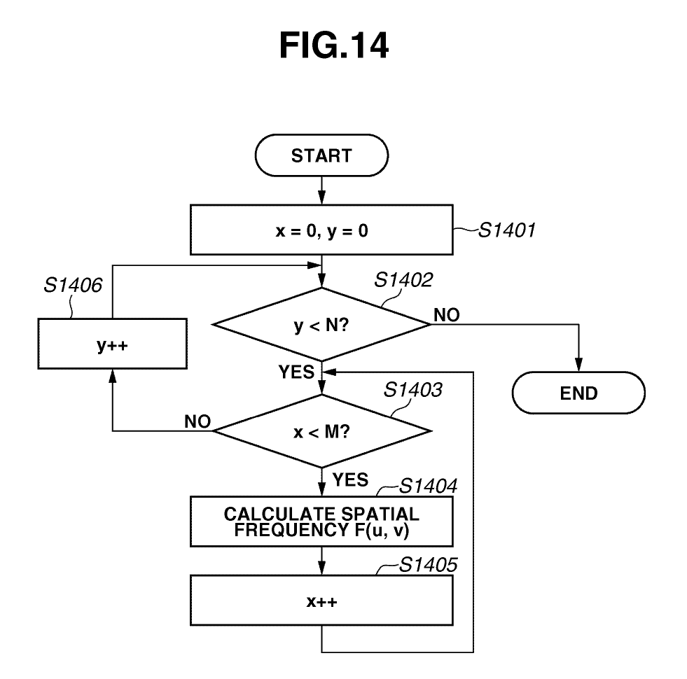

FIG. 14 is a flowchart illustrating an example procedure of the spatial frequency calculation processing that can be performed by the controller 20 of the image processing apparatus. To realize the processing illustrated in FIG. 14, an appropriate control program is stored in the ROM 203 as described above and can be executed by the CPU 201.

In FIG. 14, first in step S1401, the CPU 201 initializes a main scanning direction counter “x” and a sub scanning direction counter “y.” Then, in step S1402, the CPU 201 determines whether the sub scanning direction counter “y” is less than a height N of the image data.

If it is determined that the sub scanning direction counter “y” is less than the height N of the image data (YES in step S1402), then in step S1403, the CPU 201 determines whether the main scanning direction counter “x” is less than a width M of the image data.

If it is determined that the main scanning direction counter “x” is less than the width M of the image data (YES in step S1403), then in step S1404, the CPU 201 calculates a spatial frequency F(u, v) at the image coordinates (x, y) using the following formula (2).

In the following formula, M and N are numerical values that define an actually drawn area. Formula (2) is discrete Fourier conversion in a two-dimensional space. In a case where the size of image data is large, low-frequency components increase and, therefore, it becomes necessary to increase calculation accuracy. In this case, both the image data width M and the height N are clipped.

$$F ( u , v ) = \frac{1}{MN} {\sum }_{m = 0}^{M - 1} {\sum }_{n = 0}^{N - 1} f ( x , y ) x exp \{ - j 2 π ( \frac{mu}{M} + \frac{nv}{N} ) \} \qquad ( 2 )$$

Next, in step S1405, the CPU 201 increments the main scanning direction counter “x” by one. Then, the processing returns to step S1403. On the other hand, if it is determined that the main scanning direction counter “x” is equal to or greater than the width M (NO in step S1403), then in step S1406, the CPU 201 increments the sub scanning direction counter “y” by one and the processing returns to step S1402.

On the other hand, if it is determined that the sub scanning direction counter “y” is equal to or greater than the height N (NO in step S1402), the CPU 201 determines that the spatial frequency calculation processing for the entire image data has been completed and terminates the processing routine illustrated in FIG. 14.

An example of processing for calculating a maximum power spectrum indicating a frequency component of an input image (i.e., processing in step S1306 illustrated in FIG. 13) is described below in more detail. In the present exemplary embodiment, the CPU 201 determines image, graphics, and text attributes that indicate features of image data based on the spatial frequency of the input image described in FIG. 14 and a threshold of an effective power spectrum.

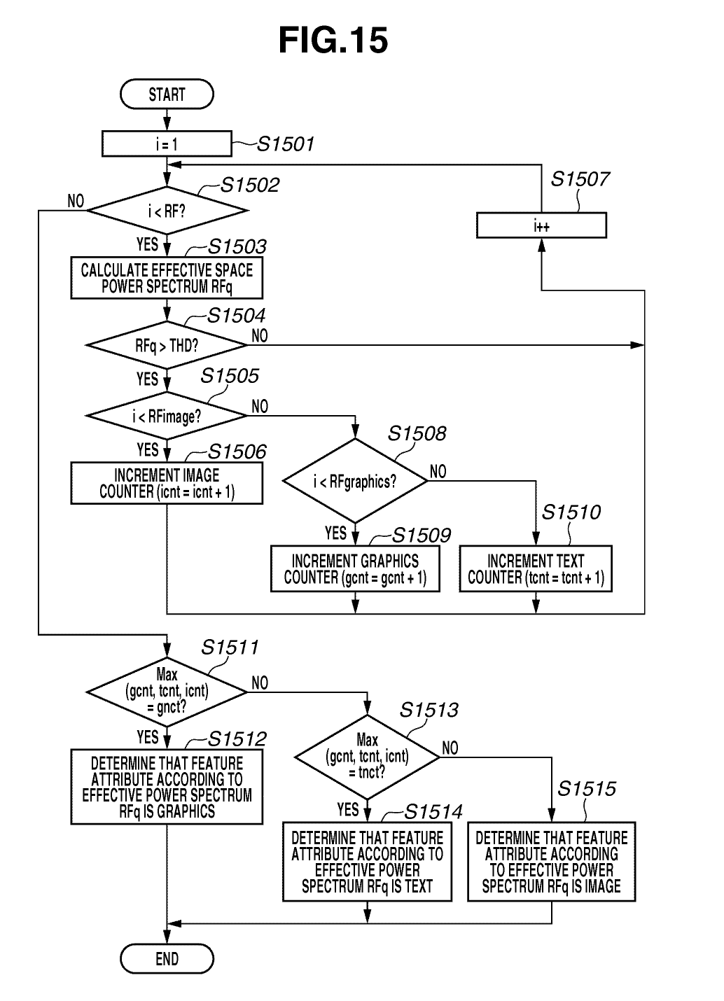

FIG. 15 is a flowchart illustrating an example procedure of image data feature attribute extraction processing applied to an input image that can be performed by the controller 20 of the image processing apparatus. To realize the processing illustrated in FIG. 15, an appropriate control program is stored in the ROM 203 as described above and can be executed by the CPU 201.

In FIG. 15, first in step S1501, the CPU 201 initializes an effective space coordinate counter “i” to 1 (i.e., i=1). In step S1502, the CPU 201 determines whether the effective space coordinate counter “i” is less than an effective space distance RF. In the present exemplary embodiment, the CPU 201 calculates the effective space distance RF (hereinafter, “RF” represents a maximum value of the effective space distance) using the following formula (3).

$$RF = \sqrt{{( \frac{M}{2} )}^{2} + {( \frac{N}{2} )}^{2}} \qquad ( 3 )$$

Next, if it is determined that the effective space coordinate counter “i” is less than the effective space distance RF (YES in step S1502), then in step S1503, the CPU 201 calculates an effective space power spectrum RFq at the effective space coordinate counter “i” using the following formula.

$$RFq = {\sum }_{u = 0}^{i} {\sum }_{v = 0}^{i} F ( u , v ) if \sqrt{{u}^{2} + {v}^{2}} = i$$

Next, in step S1504, the CPU 201 determines whether the effective space power spectrum RFq calculated in step S1503 is greater than an attribute determination threshold THD. If it is determined that the effective space power spectrum RFq is greater than the attribute determination threshold THD (YES in step S1504), then in step S1505, the CPU 201 determines whether the effective space coordinate counter “i” is less than a graphics attribute determination threshold RFimage.

If it is determined that the effective space coordinate counter “i” is less than the graphics attribute determination threshold RFimage (YES in step S1505), then in step S1506, the CPU 201 increments an image counter icnt by one. Then, in step S1507, the CPU 201 increments the effective space coordinate counter “i” by one. Then, the processing returns to step S1502.

On the other hand, if it is determined that the effective space coordinate counter “i” is equal to or greater than the graphics attribute determination threshold RFimage (NO in step S1505), then in step S1508, the CPU 201 determines whether the effective space coordinate counter “i” is less than a text attribute determination threshold RFgraphic.

If it is determined that the effective space coordinate counter “i” is less than the text attribute determination threshold RFgraphic (YES in step S1508), then in step S1509, the CPU 201 increments the graphics counter gcnt by one and the processing proceeds to step S1507.

On the other hand, if it is determined that the effective space coordinate counter “i” is equal to or greater than the text attribute determination threshold RFgraphic (NO in step S1508), then in step S1510, the CPU 201 increments the text counter tcnt by one and the processing proceeds to step S1507. On the other hand, if it is determined that the effective space power spectrum RFq is equal to or less than the attribute determination threshold THD (NO in step S1504), the processing proceeds to step S1507.

On the other hand, if it is determined that the effective space coordinate counter “i” is equal to or greater than the effective space distance RF (NO in step S1502), then in step S1511, the CPU 201 determines whether the graphics counter gcnt is the largest among the graphics counter gcnt, the text counter tcnt, and the image counter icnt.

If it is determined that the graphics counter gcnt is the largest (YES in step S1511), then in step S1512, the CPU 201 determines that the feature attribute according to the effective space power spectrum RFq is graphics and terminates the processing routine illustrated in FIG. 15.

On the other hand, if it is determined that the graphics counter gcnt is not the largest (NO in step S1511), then in step S1513, the CPU 201 determines whether the text counter tcnt is the largest. If it is determined that text counter tcnt is the largest (YES in step S1513), then in step S1514, the CPU 201 determines that the feature attribute according to the effective space power spectrum RFq is text and terminates the processing routine illustrated in FIG. 15.

On the other hand, if it is determined that the text counter tcnt is not the largest (NO in step S1513), then in step S1515, the CPU 201 determines that the feature attribute according to the effective space power spectrum RFq is image and terminates the processing routine illustrated in FIG. 15.

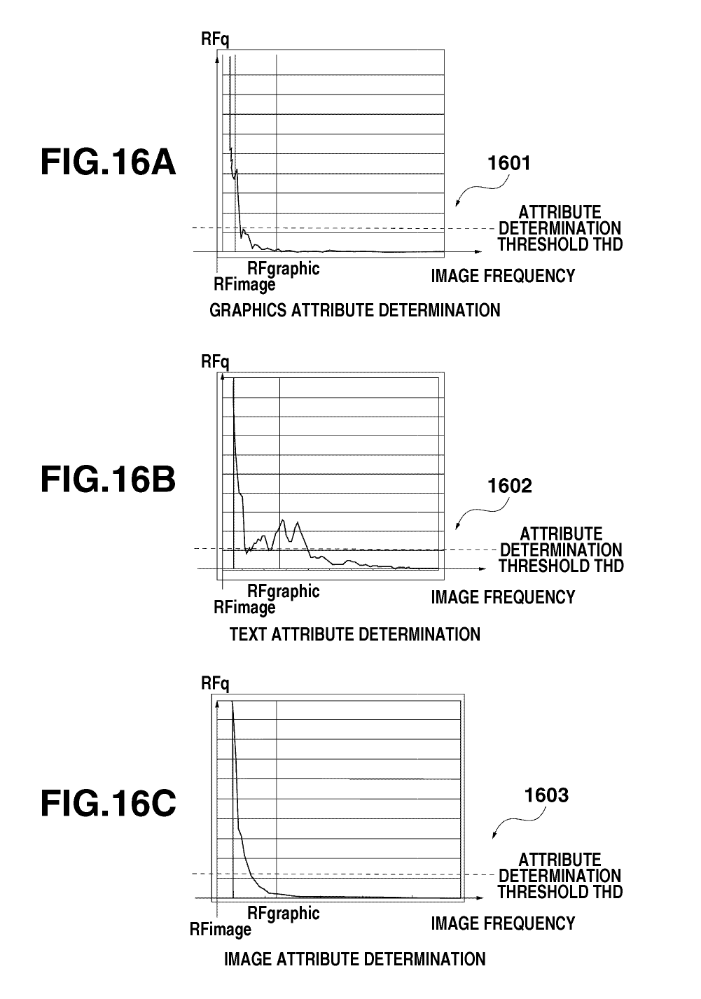

FIGS. 16A to 16C illustrate examples of a relationship between the effective space power spectrum RFq (y axis) and the spatial frequency (x axis) obtained though the above-described processing. FIG. 16A illustrates an example case 1601 relating to graphics attribute determination. FIG. 16B illustrates an example case 1602 relating to text attribute determination. FIG. 16C illustrates an example case 1603 relating to image attribute determination.

In this manner, spatial frequency characteristics of image data can be used to identify the attribute of an image. For example, if the amount of high-frequency components is relatively large, this image can be identified as having the text attribute. Similarly, if the amount of low-frequency components is relatively large, this image can be identified as having the image attribute. The rest of the images can be identified as having the graphics attribute.

An example of the partial area extraction processing to be performed when the super-resolution processing is applied to a partial area in step S1311 illustrated in FIG. 13 is described below in more detail. In the present exemplary embodiment, the CPU 201 calculates attribute values of pixels in each block based on their frequency characteristics and extracts a block that has a largest value with respect to each attribute value, when low-resolution image data that constitutes one frame is received from the scanner unit 11 via the scanner I/F 211. Then, the CPU 201 determines a partial area.

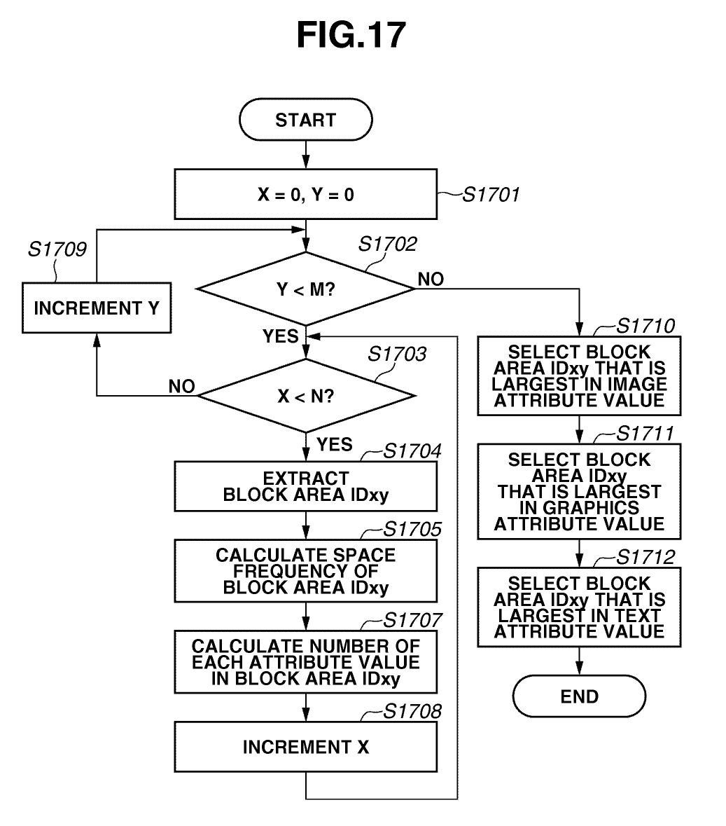

FIG. 17 is a flowchart illustrating another example of the partial area extraction processing that can be performed by the controller 20 of the image processing apparatus. To realize the processing illustrated in FIG. 17, an appropriate control program is stored in the ROM 203 as described above and can be executed by the CPU 201. In the present exemplary embodiment, the CPU 201 divides image data into N×M blocks to perform partial area extraction processing.

Further, processing to be performed in steps S1701 through S1704 and processing to be performed in steps S1708 through S1712 are similar to the processing described in the first exemplary embodiment with reference to FIG. 11.

In step S1705, the CPU 201 calculates a spatial frequency of image data included in the block area IDxy extracted in step S1704. To calculate the spatial frequency, the CPU 201 can use a method similar to that described with reference to FIG. 14.

Next, in step S1707, the CPU 201 calculates the number of each attribute value in the block area IDxy calculated in step S1705. The above-described processing is for the maximum power spectrum calculation and image data feature attribute extracting processing illustrated in FIG. 15. For the above-described calculation, the CPU 201 performs the processing of steps S1501 to S1510.

Through the above-described processing, the second exemplary embodiment can extract features of input image data based on its spatial frequency and can automatically determine a desired resolution to output an image having the extracted features. Then, the second exemplary embodiment can perform a preview display of a partial area of an output image in a case where the super-resolution conversion is performed to output an image having a determined resolution as well as in a case where the super-resolution conversion is performed to output a referential image having a higher resolution increased by one level and another referential image having a lower resolution reduced by one level.

Further, the present exemplary embodiment can display a numerical value indicating a data amount in addition to an image. Therefore, users can simply obtain a desired super-resolution output considering both image quality to be realized and the data amount.

A third exemplary embodiment of the present invention is characteristic in that the preview display is occasionally performed in order of smallness in data amount to be used for the preview of a super-resolution processed image. In the following description, processing similar to that described in the first exemplary embodiment is denoted by the same reference numeral and the description for the same is not repeated.

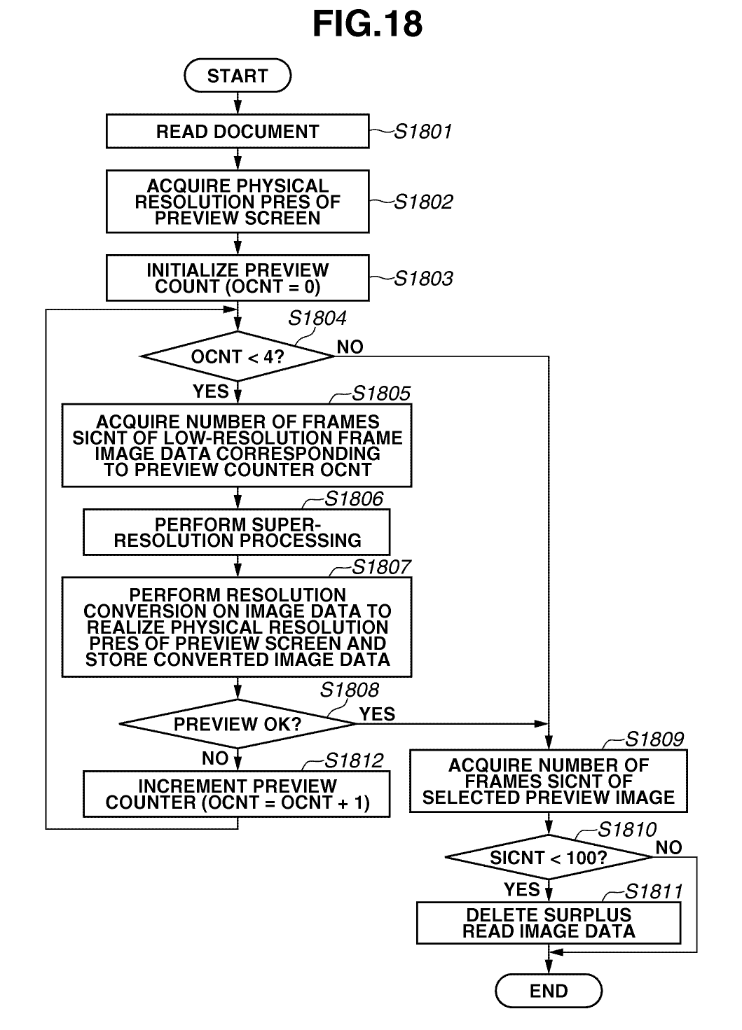

FIG. 18 is a flowchart illustrating another example of the super-resolution processing mode setting processing that can be performed by the controller 20 of the image processing apparatus. To realize the processing illustrated in FIG. 18, an appropriate control program is stored in the ROM 203 as described above and can be executed by the CPU 201.

First, in step S1801, the CPU 201 causes the scanner unit 11 to perform a document reading operation. Then, in step S1802, the CPU 201 acquires a physical resolution PRES of a preview screen to be displayed by the operation unit 13. Next, in step S1803, the CPU 201 initializes the preview counter OCNT (i.e., OCNT=0).

Next, in step S1804, the CPU 201 compares the preview counter OCNT with a threshold value 4. In the present exemplary embodiment, setting of the threshold value 4 indicates that the CPU 201 realizes super-resolution processing of four levels at maximum on preview image data to be displayed on the operation unit 13.

If it is determined that the preview counter OCNT is less than the threshold value 4 (YES in step S1804), then in step S1805, the CPU 201 acquires a number of frames SICNT corresponding to the preview counter OCNT. In the present exemplary embodiment, the correspondence information table illustrated in FIG. 7 that defines a relationship between the preview counter OCNT and the number of frames SICNT at each output resolution is stored in the ROM 203.

Next, in step S1806, the CPU 201 performs super-resolution processing using frame image data of low-resolution images corresponding to the number of frames acquired in step S1805. In step S1807, the CPU 201 performs resolution conversion on the image data to realize the physical resolution PRES of the preview screen and displays the preview screen on the operation unit 13.

In this case, the CPU 201 displays the number of frames SICNT of the frame image data of the low-resolution images acquired in step S1805 together with size information of image data required in the processing on the operation unit 13. In this case, the size of the image data required in the processing is equal to A×SICNT (Byte) when “A” (Byte) represents a data size of low-resolution frame image data that constitute one frame. As described above, the CPU 201 can successively display preview images of image data to be generated by the super-resolution processing.

Next, in step S1808, the CPU 201 determines whether to perform super-resolution processing according to the preview image displayed on the operation unit 13 in step S1807. If it is determined that selection of an OK button instructing the super-resolution processing is received from a user (YES in step S1808), then in step S1809, the CPU 201 acquires a number of frames SICNT that corresponds to the preview counter OCNT from the operation unit 13 via the operation unit I/F 205.

Then, in step S1810, the CPU 201 compares the acquired number of frames SICNT with a maximum acquisition number of frames (=100). If it is determined that the number of frames SICNT is less than the maximum acquisition number of frames (=100) (YES in step S1810), then in step S1811, the CPU 201 deletes the surplus of read image data and terminates the processing routine illustrated in FIG. 18.

On the other hand, if it is determined that selection of a button instructing super-resolution processing realizing an image quality of the next level is received from the user (NO in step S1808), then in step S1812, the CPU 201 increments the preview counter OCNT by one. Then, the processing returns to step S1804.

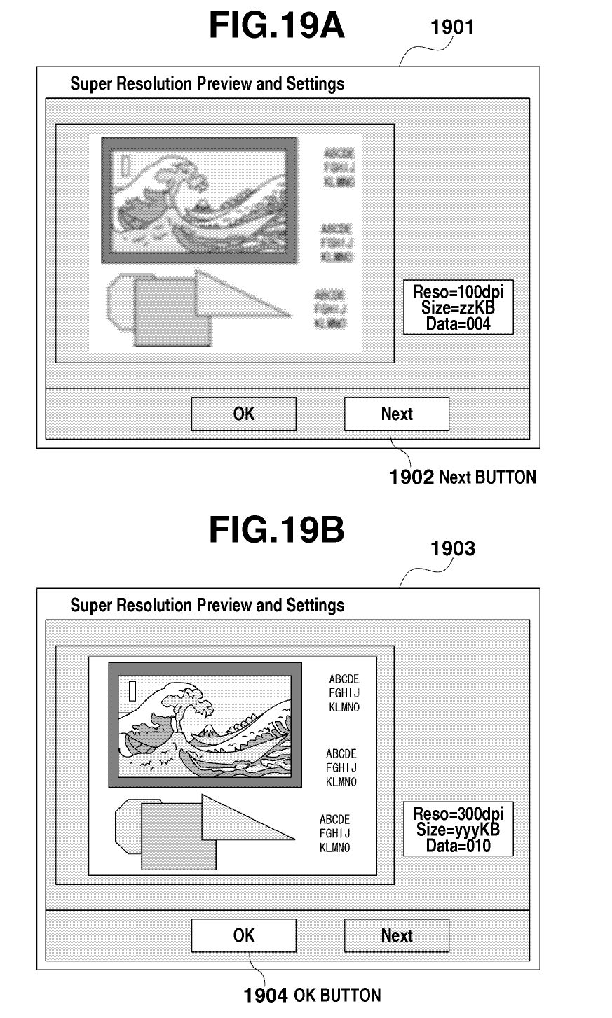

FIGS. 19A and 19B illustrate example cases where a user sets an output image while confirming a preview screen generated by the super-resolution processing on the operation unit 13. FIG. 19A illustrates a preview screen 1901 displayed in the initial super-resolution processing (corresponding to 100 dpi in the present exemplary embodiment), according to which selection of a Next button 1902 is received from a user.

FIG. 19B illustrates a preview screen 1903 displayed in the next level of super-resolution processing (corresponding to 300 dpi in the present exemplary embodiment), according to which selection of an OK button 1904 is received from the user. In this case, the CPU 201 determines that a mode selection for the super-resolution processing has been completed.

FIG. 19B is a case where the selected mode for the super-resolution processing is 300 dpi. Through the above-described processing, the third exemplary embodiment can perform the preview display of input image data in order of smallness in data amount to be used in the super-resolution processing.

Further, the third exemplary embodiment can display a data amount in addition to an image. Therefore, users can simply obtain a desired super-resolution output considering both image quality to be realized and the data amount. Further, the third exemplary embodiment can perform a preview display of the entire image to enable users to easily confirm details of a resolution converted image.

In the first to third exemplary embodiments, the CPU 201 deletes the surplus of data after completing the mode setting for the super-resolution processing. A fourth exemplary embodiment of the present invention is characteristic in that image data required for the super-resolution processing higher and lower in level compared to the determined super-resolution processing are not included in the surplus data to be deleted.

In the fourth exemplary embodiment, the CPU 201 performs processing similar to the processing illustrated in FIG. 6, as described above in the first exemplary embodiment. In the present exemplary embodiment, the CPU 201 does not “acquire the number of frames SICNT of the selected preview image.” Instead, in step S617, the CPU 201 “acquires a number of frames SICNT that corresponds to the preview counter OCNT+1”.

Then, in step S618, the CPU 201 compares the acquired number of frames SICNT with the maximum acquisition number of frames (=100). Thus, the fourth exemplary embodiment can reproduce image data whose resolution is one level higher than the determined resolution image and can reproduce image data whose resolution is one level lower than the determined resolution image.

If it is determined that the number of frames SICNT of low-resolution images is less than the maximum acquisition number of frames (=100) (YES in step S618), then in step S619, the CPU 201 deletes the surplus of read image data and terminates the processing routine illustrated in FIG. 6.

Through the above-described processing, the image data required for the super-resolution processing higher and lower in level compared to the determined super-resolution processing can be prevented from being included in the surplus data to be deleted. Users can simply obtain images whose resolution is one level higher or lower compared to the determined image quality.

In the first exemplary embodiment, the image processing apparatus performs a preview display of a super-resolution processed image. A fifth exemplary embodiment of the present invention is characteristic in that the image processing apparatus performs a preprint of an output image that can bring effects similar to those of the preview display.

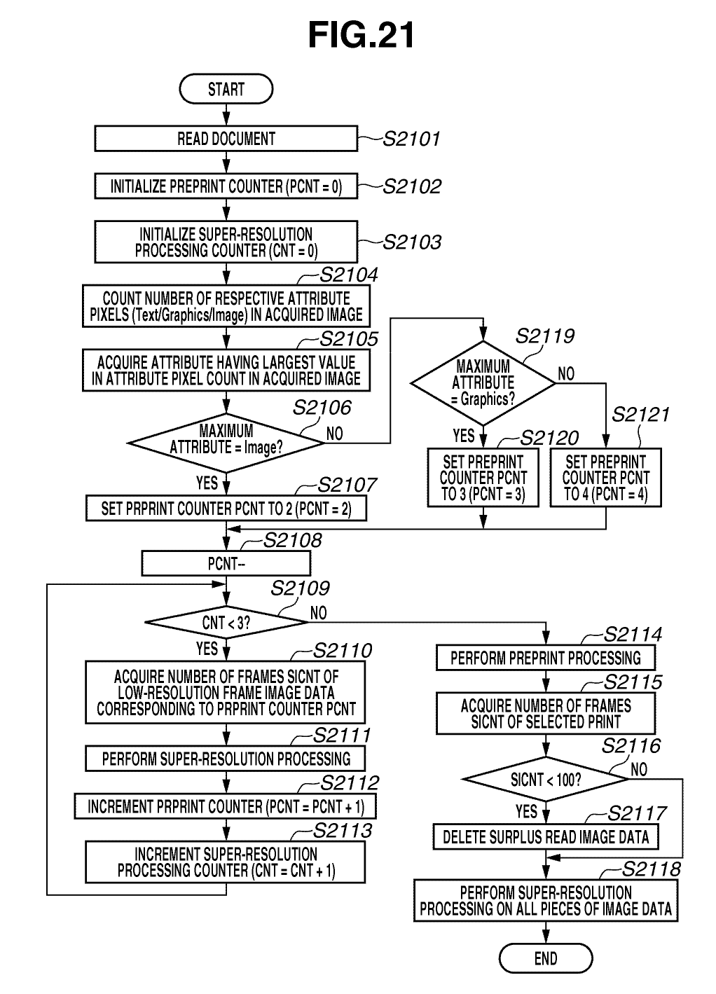

FIG. 21 is a flowchart illustrating another example of the super-resolution processing mode setting processing that can be performed by the controller 20 of the image processing apparatus. To realize the processing illustrated in FIG. 21, an appropriate control program is stored in the ROM 203 as described above and can be executed by the CPU 201.

First, in step S2101, the CPU 201 causes the scanner unit 11 to perform a document reading operation. In step S2102, the CPU 201 initializes a preprint counter PCNT (i.e., PCNT=0). In step S2103, the CPU 201 initializes the super-resolution processing counter CNT (i.e., CNT=0).

Next, in step S2104, the CPU 201 counts the number of pixels having each attribute from the first frame of an input image acquired by the scanner unit 11. In step S2105, the CPU 201 acquires attribute information with respect to the largest counted number of pixels of each attribute.

Next, in step S2106, if it is determined that the attribute information acquired in step S2105 is the image attribute, then in step S2107, the CPU 201 sets the preprint counter to 2 (i.e., PCNT=2). Then, in step S2108, the CPU 201 decrements the preprint counter PCNT by one.

Next, in step S2109, the CPU 201 compares the super-resolution processing counter CNT with the threshold value 3. In the present exemplary embodiment, setting of the threshold value 3 indicates that the CPU 201 performs three types of super-resolution processing to display preprint image data on the operation unit 13.

If it is determined that the super-resolution processing counter CNT is less than the threshold value 3 (YES in step S2109), then in step S2110, the CPU 201 acquires the number of frames SICNT corresponding to the preprint counter PCNT. In the present exemplary embodiment, a correspondence information table that defines a relationship between the preprint counter PCNT and the number of frames SICNT at each output resolution is stored in the ROM 203.

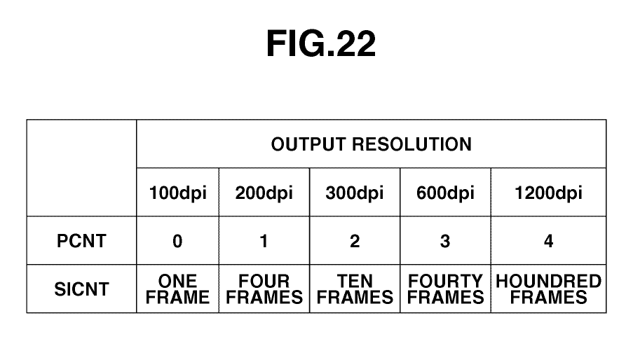

FIG. 22 illustrates an example of the correspondence table stored in the ROM 203, which defines a relationship between the preprint counter PCNT and the number of frames SICNT at each output resolution. For example, in a case where the preprint counter value is 2 (PCNT=2), a desired output resolution is 300 dpi. In this case, an amount of low-resolution frame image data required to acquire an image of 300 dpi is comparable to 10 frames.

The correspondence table can be prepared beforehand considering performances of each device or can be arbitrarily changed by each user.

Next, in step S2111, the CPU 201 performs super-resolution processing on a target partial area corresponding to the number of frames acquired in step S2110.

Next, in step S2112, the CPU 201 increments the preprint counter PCNT by one. In step S2113, the CPU 201 increments the super-resolution processing counter CNT by one. Then, the processing returns to step S2109.

On the other hand, if it is determined that the super-resolution processing counter CNT is equal to or greater than the threshold value 3 (NO in step S2109), then in step S2114, the CPU 201 determines the super-resolution processing for the above-described three types of preprints has been completed and causes the printer unit 12 to perform preprint processing.

In this case, the CPU 201 displays the number of frames SICNT acquired in step S2110 together with size information of image data required in the processing. In this case, the size of the image data required in the processing is equal to A×SICNT (Byte) when “A” (Byte) represents a data size of low-resolution frame image data that constitute one frame.

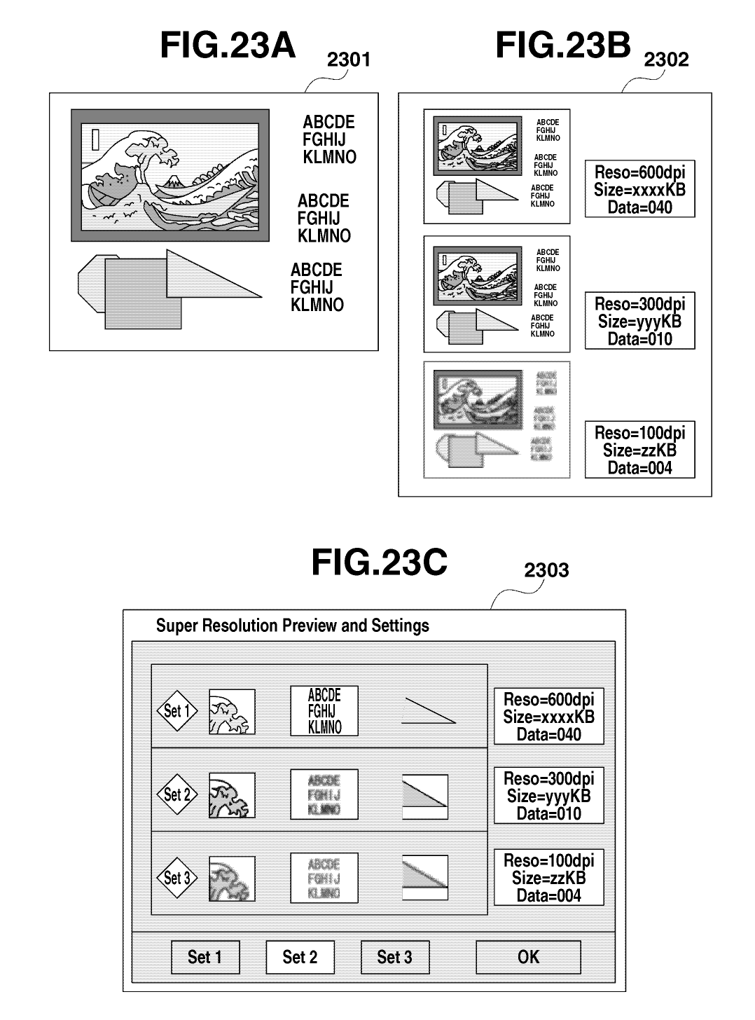

FIGS. 23A, 23B, and 23C illustrate example cases where a user sets an output image while confirming a preprint output generated by the super-resolution processing on the operation unit 13. FIG. 23A illustrates an input document 2301. FIG. 23B illustrates output images 2302 that are actually output as preprints. FIG. 23C illustrates a selection screen 2303 displayed on the operation unit 13. According to the illustrated examples, image attribute information is the largest. Details of the contents illustrated in FIGS. 23A, 23B, and 23C are similar to those illustrated in FIGS. 8A and 8B.

Next, in step S2115, the CPU 201 acquires a number of frames SICNT corresponding to the preprint counter PCNT from the operation unit 13 via the operation unit I/F 205 that has received a user's instruction of executing the super-resolution processing. Then, in step S2116, the CPU 201 compares the acquired number of frames SICNT with a maximum acquisition number of frames (=100).

If it is determined that the number of frames SICNT is less than the maximum acquisition number of frames (=100) (YES in step S2116), then in step S2117, the CPU 201 deletes the surplus of read image data.

Next, in step S2118, the CPU 201 performs super-resolution processing on all pieces of image data and terminates the processing routine illustrated in FIG. 21.

On the other hand, if it is determined that the attribute information acquired in step S2105 is the graphics attribute (YES in step S2119), then in step S2120, the CPU 201 sets the preprint counter PCNT to 3 (PCNT=3). Then, the processing proceeds to step S2108.

On the other hand, if it is determined that the attribute information acquired in step S2105 is the text attribute (NO in step S2106 and NO in step S2119), then in step S2121, the CPU 201 sets the preprint counter PCNT to 4 (PCNT=4). Then, the processing proceeds to step S2108.

Through the above-described processing, the fifth exemplary embodiment can extract features of input image data based on its attribute information and can automatically output a preprint of an image to be generated by desired super-resolution processing as well as preprints of additional images to be generated by one-level higher and lower super-resolution processing. Further, the present exemplary embodiment can display a data amount in addition to an image. Therefore, users can simply obtain a desired super-resolution output considering both image quality to be realized and the data amount.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-167905 filed Jul. 16, 2009, which is hereby incorporated by reference herein in its entirety.

What is claimed is:

1. An apparatus comprising:
a sensor unit including a plurality of sensors, of which a first sensor and a second sensor are disposed adjacent to each other such that a shift between the first sensor and the second sensor in a reading position of an image is less than one pixel;
a determination unit configured to acquire attribute information of the image and to determine a plurality of resolutions according to the acquired attribute information;
a frame number determination unit configured to determine a number of frames of frame image data, from a plurality of pieces of frame image data, to convert the image into each of the plurality of pieces of image data having the respective plurality of resolutions;
a first conversion unit configured to generate the plurality of pieces of image data by performing interpolation processing on a partial area of the image using frame image data that corresponds to the number of frames;
an output unit configured to display on a preview screen the plurality of pieces of image data; and
a second conversion unit configured to generate image data having a resolution higher than a reading resolution by performing interpolation processing using frame image data corresponding to the number of frames used to generate image data selected among the plurality of pieces of image data.

2. The apparatus according to claim 1, wherein the second conversion unit is configured to delete image data other than the frame image data corresponding to the number of frames.

3. The apparatus according to claim 1, wherein the partial area of the image is an area that is largest in number of pixels having an image attribute, an area that is largest in number of pixels having a text attribute, and an area that is largest in number of pixels having a graphics attribute, among areas obtained by dividing one frame of image data unit into a plurality of areas.

4. The apparatus according to claim 1, wherein the attribute information represents a feature of the image that is obtained by identifying attributes of respective pixels that constitute image data constituting one frame, of the frame image data, and by determining a representative attribute that is largest in a counted number of pixels having each attribute.

5. The apparatus according to claim 1, further comprising:
a calculation unit configured to calculate a spatial frequency of image data constituting one frame, of the frame image data,
wherein the attribute information represents a feature of the image that is obtained by calculating a maximum power spectrum based on a result obtained by the calculation unit and by determining a representative attribute of the image data based on a result of the calculation.

6. A method for controlling an apparatus including a sensor unit including a plurality of sensors, of which a first sensor and a second sensor are disposed adjacent to each other such that a shift between the first sensor and the second sensor in a reading position of an image is less than one pixel, the method comprising;
acquiring attribute information of the image and determining a plurality of resolutions according to the acquired attribute information;
determining a number of frames of frame image data, from a plurality of pieces of frame image data, which are used to convert the image into each of a plurality of pieces of image data having the respective plurality of resolutions;
generating a plurality of pieces of image data by performing interpolation processing on a partial area of the image using frame image data that corresponds to the determined number of frames;
displaying on a preview screen the generated plurality of pieces of image data; and
generating image data having a resolution higher than a reading resolution by performing interpolation processing using frame image data corresponding to the number of frames used to generate image data.

7. The method according to claim 6, further comprising deleting image data other than the frame image data corresponding to the number of frames used to generate the selected image data.

8. The method according to claim 6, wherein the partial area of the document image is an area that is largest in number of pixels having an image attribute, an area that is largest in number of pixels having a text attribute, and an area that is largest in number of pixels having a graphics attribute, among areas obtained by dividing one frame of image data into a plurality of areas.

9. The method according to claim 6, wherein the attribute information represents a feature of the image that is obtained by identifying attributes of respective pixels that constitute image data constituting one frame, and by determining a representative attribute that is largest in a counted number of pixels having each attribute.

10. The method according to claim 6, further comprising:
calculating a spatial frequency of image data constituting one frame of the frame image data,
wherein the attribute information represents a feature of the image that is obtained by calculating a maximum power spectrum based on the calculated spatial frequency and by determining a representative attribute of the image data based on a result of the calculation.

11. A computer-readable storage medium storing a control program that causes a computer to control an apparatus including a sensor unit including a plurality of sensors, of which a first sensor and a second sensor are disposed adjacent to each other in such a manner that a shift between the first sensor and the second sensor in a reading position of a document image is less than one pixel, the control program comprising;
computer-executable instructions for acquiring attribute information of the image and determining a plurality of resolutions according to the acquired attribute information;
computer-executable instructions for determining a number of frames of frame image data, from a plurality of pieces of frame image data, which are used to convert the document image into each of the plurality of pieces of image data having the respective plurality of resolutions;
computer-executable instructions for generating the plurality of pieces of image data having the respective plurality of resolutions by performing interpolation processing on a partial area of the image using frame image data that corresponds to the determined number of frames;
computer-executable instructions for displaying on a preview screen the generated plurality of pieces of image data; and
computer-executable instructions for generating image data having a resolution higher than a reading resolution by performing interpolation processing using frame image data corresponding to the number of frames used to generate image data selected among the displayed plurality of pieces of image data.

12. The computer-readable storage medium according to claim 11, further comprising computer-executable instructions for deleting image data other than the frame image data corresponding to the number of frames used to generate the selected image data.

13. The computer-readable storage medium according to claim 11, wherein the partial area of the document image is an area that is largest in number of pixels having an image attribute, an area that is largest in number of pixels having a text attribute, and an area that is largest in number of pixels having a graphics attribute, among areas obtained by dividing one frame of image data into a plurality of areas.

14. The computer-readable storage medium according to claim 11, wherein the attribute information represents a feature of the image that is obtained by identifying attributes of respective pixels that constitute image data constituting one frame, and by determining a representative attribute that is largest in a counted number of pixels having each attribute.

15. The computer-readable storage medium according to claim 11, further comprising:
computer-executable instructions for calculating a spatial frequency of image data constituting one frame of the frame image data,
wherein the attribute information represents a feature of the image that is obtained by calculating a maximum power spectrum based on the calculated spatial frequency and by determining a representative attribute of the image data based on a result of the calculation.
